(19) United States
(12) Patent Application Publication
(10) Pub. No.: US 2026/0087357 A1
(43) Pub. Date: Mar. 26, 2026

(54) Prompt Tuning Pipeline

(71) Applicant: ServiceNow, Inc., Santa Clara, CA (US)

(72) Inventors: Dariush Shahgoshtasbi, Bellevue, WA (US); Gaurav Goyal, Santa Clara, CA (US); Tao Feng, Palo Alto, CA (US)

(21) Appl. No.: 18/898,154

(22) Filed: Sep. 26, 2024

(51) Int. Cl. G06N 3/091; G06N 3/042

(52) U.S. Cl. CPC G06N 3/091; G06N 3/042

(57) ABSTRACT

Embodiments are provided to distill the knowledge of a large model with respect to a tasks into a prompt that can be applied to a smaller model in order to improve the smaller model's performance of the task. This is accomplished by generating, by the large model, a set of queries and associated prompt segments related to sub-tasks, background knowledge, or other information about the tasks that may not be represented adequately by the smaller model. The smaller model's responses to the queries are assessed and, if found to represent reduced competence, the corresponding prompt segment is added to a model-specific prompt. The model-specific prompt is thus selectively expanded to include prompt segments that compensate for incompetencies of the smaller model with respect to corresponding aspects (e.g., sub-tasks) of the task instructed by the prompt.

### BACKGROUND

Generative natural language models can perform a variety of tasks, including question answering and otherwise responding to free-form textual prompts. A larger models is, in general, capable of providing better responses, based on a correspondingly larger knowledge base. Larger models may adhere better to specific formatting or other constraints instructed in the input prompts. However, training, inference, and other tasks (e.g., maintaining model parameters in a database for later use) related to larger models are more computationally expensive and require more power relative to similar tasks performed using smaller models.

### SUMMARY

The embodiments described herein enable a smaller (e.g., less computationally expensive) language model to accomplish various specified task(s) accurately, without fine-tuning or otherwise retraining the smaller model on the specified task(s). This is accomplished by traversing a graph or similar structure to assemble a prompt that instructs the smaller model to accomplish the task while also providing an amount of contextual information that is specifically tailored to the smaller model, including additional prompt contents for aspects of the task with which the smaller model is unfamiliar. At each node or other decision point in the structure, a corresponding question is posed as input to the smaller model to assess whether the smaller model is competent with respect to knowledge or context that is relevant to the task. The smaller model's response is then assessed (e.g., by application to a larger model) to determine whether the smaller model is competent with respect to the topic of the question. If the smaller model is not competent, a corresponding segment is added to the prompt being assembled (e.g., to provide instructions, an example, or some other information to assist the smaller model in performing the task by augmenting the smaller model's knowledge of a corresponding topic relevant to the task). Once the graph has been traversed, the completed prompt can be input to the smaller model to perform the task in an improved manner (e.g., with an accuracy similar to that obtained by using a larger model) while using the reduced amount of memory, processor cycles, power, or other computational costs of executing the smaller model relative to a larger model.

Accordingly, a first example embodiment may involve a method that includes: (i) providing, to a first model, a query to generate a response; (ii) determining that the first model satisfies an error threshold with respect to the query; (iii) in response to determining the error threshold is satisfied, generating a model-specific prompt that is associated with the first model; and (iv) providing, to the first model, the model-specific prompt.

A second example embodiment may involve a method that includes: (i) providing a prompt to a first model to generate a plurality of queries and respective prompt segments, wherein the prompt includes (a) an instruction to identify a set of sub-tasks of a target task, (b) an instruction to generate the plurality of queries such that each query of the plurality of queries assesses a competence of a model at performing a respective sub-task of the set of sub-tasks, and (c) an instruction to generate the prompt segments such that, if an answer to a given one of the queries that indicates incompetence of a target model with respect to the respective sub-task, providing the respective prompt segment to the target model will increase competence of the target model with respect to the respective sub-task; (ii) providing, to a second model that includes fewer parameters than the first model, the plurality of queries to generate respective responses; (iii) determining a subset of the responses that satisfy an error threshold with respect to respective queries of the plurality of queries; and (iv) generating a model-specific prompt for the second model by adding, to the model-specific prompt, a subset of the prompt segments that correspond to the subset of the responses.

A third example embodiment may involve a non-transitory computer-readable medium, having stored thereon program instructions that, upon execution by a computing system, cause the computing system to perform operations in accordance with any of the previous example embodiments.

In a fourth example embodiment, a computing system may include at least one processor, as well as memory and program instructions. The program instructions may be stored in the memory, and upon execution by the at least one processor, cause the computing system to perform operations in accordance with any of the previous example embodiments.

In a fifth example embodiment, a system may include various means for carrying out each of the operations of any of the previous example embodiments.

These, as well as other embodiments, aspects, advantages, and alternatives, will become apparent to those of ordinary skill in the art by reading the following detailed description, with reference where appropriate to the accompanying drawings. Further, this summary and other descriptions and figures provided herein are intended to illustrate embodiments by way of example only and, as such, that numerous variations are possible. For instance, structural elements and process steps can be rearranged, combined, distributed, eliminated, or otherwise changed, while remaining within the scope of the embodiments as claimed.

### BRIEF DESCRIPTION OF THE DRAWINGS

FIG. 1 illustrates a schematic drawing of a computing device, in accordance with example embodiments.

FIG. 2 illustrates a schematic drawing of a server device cluster, in accordance with example embodiments.

FIG. 3 depicts a remote network management architecture, in accordance with example embodiments.

FIG. 4 depicts a communication environment involving a remote network management architecture, in accordance with example embodiments.

FIG. 5 depicts another communication environment involving a remote network management architecture, in accordance with example embodiments.

FIG. 6A depicts a graph of questions that can be traversed to assemble a model-specific prompt, in accordance with example embodiments.

FIG. 6B depicts a graph of questions that can be traversed to assemble a model-specific prompt, in accordance with example embodiments.

FIG. 6C depicts a graph of questions that can be traversed to assemble a model-specific prompt, in accordance with example embodiments.

FIG. 7 is a flow chart, in accordance with example embodiments.

FIG. 8A is a flow chart, in accordance with example embodiments.

FIG. 8B is a flow chart, in accordance with example embodiments.

### DETAILED DESCRIPTION

Example methods, devices, and systems are described herein. It should be understood that the words “example” and “exemplary” are used herein to mean “serving as an example, instance, or illustration.” Any embodiment or feature described herein as being an “example” or “exemplary” is not necessarily to be construed as preferred or advantageous over other embodiments or features unless stated as such. Thus, other embodiments can be utilized and other changes can be made without departing from the scope of the subject matter presented herein. Accordingly, the example embodiments described herein are not meant to be limiting. It will be readily understood that the aspects of the present disclosure, as generally described herein, and illustrated in the figures, can be arranged, substituted, combined, separated, and designed in a wide variety of different configurations. For example, the separation of software features into “client” and “server” components may occur in a number of ways.

Further, unless context suggests otherwise, the features illustrated in each of the figures may be used in combination with one another. Thus, the figures should be generally viewed as component aspects of one or more overall embodiments, with the understanding that not all illustrated features are necessary for each embodiment.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order.

Unless clearly indicated otherwise herein, the term “or” is to be interpreted as the inclusive disjunction. For example, the phrase “A, B, or C” is true if any one or more of the arguments A, B, C are true, and is only false if all of A, B, and C are false.

### I. Example Technical Improvements

These embodiments provide a technical solution to a technical problem. One technical problem being solved is the computational resource usage to perform inference using generative natural language models (e.g., large language models (LLMs)). In practice, this is problematic because such models, having many billions of parameters, are expensive to execute and/or to train with respect to power, latency, or other computational resources (e.g., memory, bandwidth to allow different processors to execute portions of the model in parallel and/or to transmit model parameters to such processors and/or memory thereof from non-volatile storage, non-volatile storage to maintain model parameters between executions). The training of such models can also be expensive with respect to the amount and diversity of training data/examples used to train the models, in addition to the considerable computational and power costs to perform such training, including fine-tuning or other training processes to adapt a pre-trained model to a specific target task. Larger models generally provide more accurate outputs that hew more closely to formatting or other instructed constraints and that are informed by a broader base of knowledge about a variety of possible tasks or other contextual information. However, such larger models employ increased power, computational, training data, and other costs.

In other techniques, the reduced computational cost of using smaller models for inference is obtained by fine-tuning or otherwise training a smaller model (from scratch, or from a pre-existing generic model) to perform a specific task, allowing the smaller model to obtain increased accuracy or provide otherwise improved outputs for a particular task. However, training itself is highly computationally expensive, employing significant expenditures of power and other resources. Additionally, the parameters of each trained smaller model must be maintained in non-volatile storage, resulting in increased storage costs as additional models are fine-tuned or otherwise trained for additional specific tasks.

The embodiments herein overcome these limitations by using a highly competent generative natural language model to generate improved prompts for a smaller model that is less competent but computationally less expensive to use. Such improved prompts include added prompt segments that provide supplemental instructions, context, background information, or other information to the smaller model to compensate for specific aspects of a task for which the smaller model is less competent. Such prompts can be generated by applying, to the smaller model, a series of queries to assess the competence of the model (e.g., corresponding to nodes of a graph of such questions and corresponding prompt segments) with respect to specific aspects of the performance of a task. The smaller model's responses are then evaluated (e.g., by the larger model) and, if they evidence lower competence on the part of the smaller model with respect to an aspect of the task, a corresponding prompt segment is added to the prompt. The added prompt segment contains information to compensate for the smaller model's incompetence with respect to the task aspect assessed by the query.

In this way, the smaller model's competence at aspects of the task can be improved by targeted prompt modification, which requires significantly less power or other computational resources (e.g., processor cycles, memory, training data) than fine-tuning or otherwise training the smaller model on the task to increase the smaller model's competence at the task. Instead, the relatively lesser power and other computational costs of performing a number of inferences using the larger and smaller models is used, to generate the initial queries and corresponding prompt segments and to use those queries to evaluate the competence of the smaller model and to generate an improved prompt therefor. Thus, once the prompt has been generated, high-quality, accurate outputs (similar in quality, e.g., to outputs generated by the larger model) can be obtained many times for the task using the less computationally expensive smaller model, avoiding the greater computational cost of performing the task using the larger model. Further, this benefit is obtained by the relatively lesser computational cost of performing inference using the larger model a few times (e.g., to generate queries and prompt segments, to evaluate smaller model responses, etc.) compared to the relatively much greater computational cost of fine-tuning or otherwise training the smaller model.

Additionally, selectively adding prompt segments to generate an improved prompt for a model can have benefits relative to simply including all of the prompt segments in the improved prompt. This is because many models (e.g., generative natural language models) have limits with respect to the size of prompts that can be applied thereto. Thus, the embodiments described herein can allow models with limited input sizes (and correspondingly lower power and other computational costs to inference) to be used to obtain more accurate or otherwise higher-quality outputs, since only the most relevant prompt segments, which address the specific competences of each smaller model, are added to the improved prompt.

Other technical improvements may also flow from these embodiments, and other technical problems may be solved. Thus, this statement of technical improvements is not limiting and instead constitutes examples of advantages that can be realized from the embodiments.

### II. Introduction

A large enterprise is a complex entity with many interrelated operations. Some of these are found across the enterprise, such as human resources (HR), supply chain, information technology (IT), and finance. However, each enterprise also has its own unique operations that provide essential capabilities and/or create competitive advantages.

To support widely-implemented operations, enterprises typically use off-the-shelf software applications, such as customer relationship management (CRM), IT service management (ITSM), IT operations management (ITOM), and human capital management (HCM) packages. However, they may also need custom software applications to meet their own unique requirements. A large enterprise often has dozens or hundreds of these custom software applications. Nonetheless, the advantages provided by the embodiments herein are not limited to large enterprises and may be applicable to an enterprise, or any other type of organization, of any size.

Many such software applications are developed by individual departments within the enterprise. These range from simple spreadsheets to custom-built software tools and databases. But the proliferation of siloed custom software applications has numerous disadvantages. It negatively impacts an enterprise's ability to run and grow its operations, innovate, and meet regulatory requirements. The enterprise may find it difficult to integrate, streamline, and enhance its operations due to lack of a single system that unifies its subsystems and data.

To efficiently create custom applications, enterprises would benefit from a remotely-hosted application platform that eliminates unnecessary development complexity. The goal of such a platform would be to reduce time-consuming, repetitive application development tasks so that software engineers and individuals in other roles can focus on developing unique, high-value features.

In order to achieve this goal, the concept of Application Platform as a Service (aPaaS) has been introduced to intelligently automate workflows throughout the enterprise. An aPaaS system is hosted remotely from the enterprise, but may access data, applications, and services within the enterprise by way of secure connections. Such an aPaaS system may have a number of advantageous capabilities and characteristics. These advantages and characteristics may be able to improve the enterprise's operations and workflows for IT, HR, CRM, customer service, application development, and security. Nonetheless, the embodiments herein are not limited to enterprise applications or environments, and can be more broadly applied.

The aPaaS system may support development and execution of model-view-controller (MVC) applications. MVC applications divide their functionality into three interconnected parts (model, view, and controller) in order to isolate representations of information from the manner in which the information is presented to the user, thereby allowing for efficient code reuse and parallel development. These applications may be web-based, and offer create, read, update, and delete (CRUD) capabilities. This allows new applications to be built on a common application infrastructure. In some cases, applications structured differently than MVC, such as those using unidirectional data flow, may be employed.

The aPaaS system may support standardized application components, such as a standardized set of widgets and/or web components for graphical user interface (GUI) development. In this way, applications built using the aPaaS system have a common look and feel. Other software components and modules may be standardized as well. In some cases, this look and feel can be branded or skinned with an enterprise's custom logos and/or color schemes.

The aPaaS system may support the ability to configure the behavior of applications using metadata. This allows application behaviors to be rapidly adapted to meet specific needs. Such an approach reduces development time and increases flexibility. Further, the aPaaS system may support GUI tools that facilitate metadata creation and management, thus reducing errors in the metadata.

The aPaaS system may support clearly-defined interfaces between applications, so that software developers can avoid unwanted inter-application dependencies. Thus, the aPaaS system may implement a service layer in which persistent state information and other data are stored.

The aPaaS system may support a rich set of integration features so that the applications thereon can interact with legacy applications and third-party applications. For instance, the aPaaS system may support a custom employee-onboarding system that integrates with legacy HR, IT, and accounting systems.

The aPaaS system may support enterprise-grade security. Furthermore, since the aPaaS system may be remotely hosted, it should also utilize security procedures when it interacts with systems in the enterprise or third-party networks and services hosted outside of the enterprise. For example, the aPaaS system may be configured to share data amongst the enterprise and other parties to detect and identify common security threats.

Other features, functionality, and advantages of an aPaaS system may exist. This description is for purpose of example and is not intended to be limiting.

As an example of the aPaaS development process, a software developer may be tasked to create a new application using the aPaaS system. First, the developer may define the data model, which specifies the types of data that the application uses and the relationships therebetween. Then, via a GUI of the aPaaS system, the developer enters (e.g., uploads) the data model. The aPaaS system automatically creates all of the corresponding database tables, fields, and relationships, which can then be accessed via an object-oriented services layer.

In addition, the aPaaS system can also build a fully-functional application with client-side interfaces and server-side CRUD logic. This generated application may serve as the basis of further development for the user. Advantageously, the developer does not have to spend a large amount of time on basic application functionality. Further, since the application may be web-based, it can be accessed from any Internet-enabled client device. Alternatively or additionally, a local copy of the application may be able to be accessed, for instance, when Internet service is not available.

The aPaaS system may also support a rich set of pre-defined functionality that can be added to applications. These features include support for searching, email, templating, workflow design, reporting, analytics, social media, scripting, mobile-friendly output, and customized GUIs.

Such an aPaaS system may represent a GUI in various ways. For example, a server device of the aPaaS system may generate a representation of a GUI using a combination of HyperText Markup Language (HTML) and JAVASCRIPT®. The JAVASCRIPT® may include client-side executable code, server-side executable code, or both. The server device may transmit or otherwise provide this representation to a client device for the client device to display on a screen according to its locally-defined look and feel. Alternatively, a representation of a GUI may take other forms, such as an intermediate form (e.g., JAVA® byte-code) that a client device can use to directly generate graphical output therefrom. Other possibilities exist, including but not limited to metadata-based encodings of web components, and various uses of JAVASCRIPT® Object Notation (JSON) and/or extensible Markup Language (XML) to represent various aspects of a GUI.

Further, user interaction with GUI elements, such as buttons, menus, tabs, sliders, checkboxes, toggles, etc. may be referred to as “selection”, “activation”, or “actuation” thereof. These terms may be used regardless of whether the GUI elements are interacted with by way of keyboard, pointing device, touchscreen, or another mechanism.

An aPaaS architecture is particularly powerful when integrated with an enterprise's network and used to manage such a network. The following embodiments describe architectural and functional aspects of example aPaaS systems, as well as the features and advantages thereof.

### III. Example Computing Devices and Cloud-Based Computing Environments

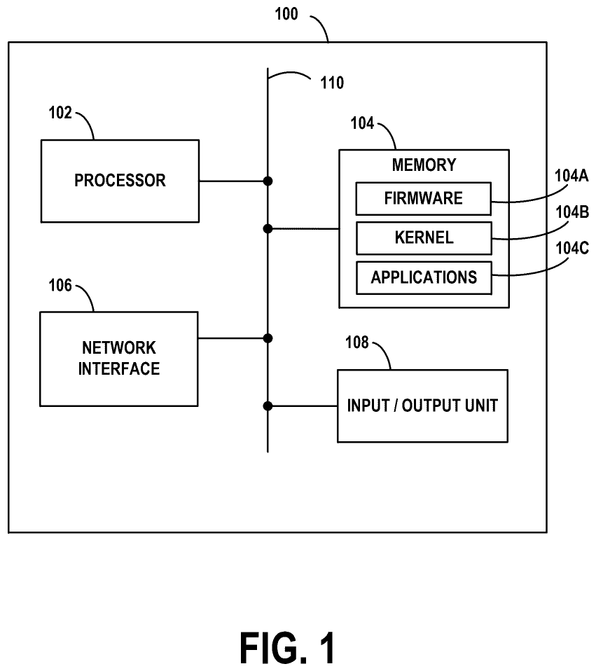

FIG. 1 is a simplified block diagram exemplifying a computing device 100, illustrating some of the components that could be included in a computing device arranged to operate in accordance with the embodiments herein. Computing device 100 could be a client device (e.g., a device actively operated by a user), a server device (e.g., a device that provides computational services to client devices), or some other type of computational platform. Some server devices may operate as client devices from time to time in order to perform particular operations, and some client devices may incorporate server features.

In this example, computing device 100 includes processor 102, memory 104, network interface 106, and input/output unit 108, all of which may be coupled by system bus 110 or a similar mechanism. In some embodiments, computing device 100 may include other components and/or peripheral devices (e.g., detachable storage, printers, and so on).

Processor 102 may be one or more of any type of computer processing element, such as a central processing unit (CPU), a graphical processing unit (GPU), a digital signal processor (DSP), a network processor, an encryption processor, and/or a form of integrated circuit or controller that performs processor operations. In some cases, processor 102 may be one or more single-core processors. In other cases, processor 102 may be one or more multi-core processors with multiple independent processing units. Processor 102 may also include register memory for temporarily storing instructions being executed and related data, as well as cache memory for temporarily storing recently used instructions and data.

GPUs, in particular, have grown in importance. They include specialized circuitry designed to perform rapid mathematical calculations for rendering graphics, processing large datasets, and supporting machine learning. A GPU typically consists of hundreds or thousands of small cores that operate simultaneously, facilitating the decomposition of tasks into smaller, more manageable pieces that are processed in parallel. This parallelism allows GPUs to be significantly faster than traditional CPUs for certain types of calculations.

Memory 104 may be any form of computer-usable memory, including but not limited to random access memory (RAM), read-only memory (ROM), and non-volatile memory (e.g., flash memory, hard disk drives, solid state drives, compact discs (CDs), digital video discs (DVDs), and/or tape storage). Thus, memory 104 represents both main memory units, as well as long-term storage. Herein, any non-volatile memory may be referred to as persistent storage.

Memory 104 may store program instructions and/or data on which program instructions may operate. By way of example, memory 104 may store these program instructions on a non-transitory, computer-readable medium, such that the instructions are executable by processor 102 to carry out any of the methods, processes, or operations disclosed in this specification or the accompanying drawings.

As shown in FIG. 1, memory 104 may include firmware 104A, kernel 104B, and/or applications 104C. Firmware 104A may be program code used to boot or otherwise initiate some or all of computing device 100. Kernel 104B may be an operating system, including modules for memory management, scheduling and management of processes, input/output, and communication. Kernel 104B may also include device drivers that allow the operating system to communicate with the hardware modules (e.g., memory units, networking interfaces, ports, and buses) of computing device 100. Applications 104C may be one or more user-space software programs, such as web browsers or email clients, as well as any software libraries used by these programs. Memory 104 may also store data used by these and other programs and applications.

Network interface 106 may take the form of one or more wireline interfaces, such as Ethernet (e.g., Fast Ethernet, Gigabit Ethernet, 10 Gigabit Ethernet, Ethernet over fiber, and so on). Network interface 106 may also support communication over one or more non-Ethernet media, such as coaxial cables or power lines, or over wide-area media, such as Synchronous Optical Networking (SONET), Synchronous Digital Hierarchy (SDH), Data Over Cable Service Interface Specification (DOCSIS), or other technologies. Network interface 106 may additionally take the form of one or more wireless interfaces, such as IEEE 802.11 (Wifi), BLUETOOTH®, global positioning system (GPS), or a wide-area wireless interface. However, other forms of physical layer interfaces and other types of standard or proprietary communication protocols may be used over network interface 106. Furthermore, network interface 106 may comprise multiple physical interfaces. For instance, some embodiments of computing device 100 may include Ethernet, BLUETOOTH®, and Wifi interfaces.

Input/output unit 108 may facilitate user and peripheral device interaction with computing device 100. Input/output unit 108 may include one or more types of input devices, such as a keyboard, a mouse, a touch screen, and so on. Similarly, input/output unit 108 may include one or more types of output devices, such as a screen, monitor, printer, and/or one or more light emitting diodes (LEDs). Additionally or alternatively, computing device 100 may communicate with other devices using a universal serial bus (USB) or high-definition multimedia interface (HDMI) port interface, for example.

In some embodiments, one or more computing devices like computing device 100 may be deployed. The exact physical location, connectivity, and configuration of these computing devices may be unknown and/or unimportant to client devices. Accordingly, the computing devices may be referred to as “cloud-based” devices that may be housed at various remote data center locations.

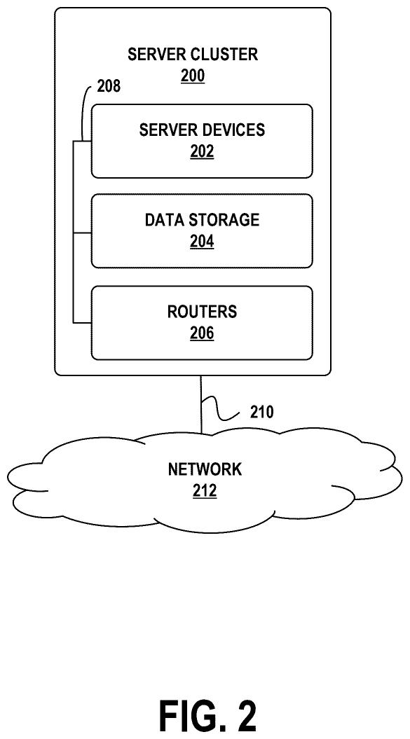

FIG. 2 depicts a cloud-based server cluster 200 in accordance with example embodiments. In FIG. 2, operations of a computing device (e.g., computing device 100) may be distributed between server devices 202, data storage 204, and routers 206, all of which may be connected by local cluster network 208. The number of server devices 202, data storages 204, and routers 206 in server cluster 200 may depend on the computing task(s) and/or applications assigned to server cluster 200.

For example, server devices 202 can be configured to perform various computing tasks of computing device 100. Thus, computing tasks can be distributed among one or more of server devices 202. To the extent that these computing tasks can be performed in parallel, such a distribution of tasks may reduce the total time to complete these tasks and return a result. For purposes of simplicity, both server cluster 200 and individual server devices 202 may be referred to as a “server device.” This nomenclature should be understood to imply that one or more distinct server devices, data storage devices, and cluster routers may be involved in server device operations.

Data storage 204 may be data storage arrays that include drive array controllers configured to manage read and write access to groups of hard disk drives and/or solid state drives. The drive array controllers, alone or in conjunction with server devices 202, may also be configured to manage backup or redundant copies of the data stored in data storage 204 to protect against drive failures or other types of failures that prevent one or more of server devices 202 from accessing units of data storage 204. Other types of memory aside from drives may be used.

Routers 206 may include networking equipment configured to provide internal and external communications for server cluster 200. For example, routers 206 may include one or more packet-switching and/or routing devices (including switches and/or gateways) configured to provide (i) network communications between server devices 202 and data storage 204 via local cluster network 208, and/or (ii) network communications between server cluster 200 and other devices via communication link 210 to network 212.

Additionally, the configuration of routers 206 can be based at least in part on the data communication requirements of server devices 202 and data storage 204, the latency and throughput of the local cluster network 208, the latency, throughput, and cost of communication link 210, and/or other factors that may contribute to the cost, speed, fault-tolerance, resiliency, efficiency, and/or other design goals of the system architecture.

As a possible example, data storage 204 may include any form of database, such as a structured query language (SQL) database or a No-SQL database (e.g., MongoDB). Various types of data structures may store the information in such a database, including but not limited to files, tables, arrays, lists, trees, and tuples. Furthermore, any databases in data storage 204 may be monolithic or distributed across multiple physical devices.

Server devices 202 may be configured to transmit data to and receive data from data storage 204. This transmission and retrieval may take the form of SQL queries or other types of database queries, and the output of such queries, respectively. Additional text, images, video, and/or audio may be included as well. Furthermore, server devices 202 may organize the received data into web page or web application representations. Such a representation may take the form of a markup language, such as HTML, XML, JSON, or some other standardized or proprietary format. Moreover, server devices 202 may have the capability of executing various types of computerized scripting languages, such as but not limited to Perl, Python, PHP Hypertext Preprocessor (PHP), Active Server Pages (ASP), JAVASCRIPT®, and so on. Computer program code written in these languages may facilitate the providing of web pages to client devices, as well as client device interaction with the web pages. Alternatively or additionally, JAVA® may be used to facilitate generation of web pages and/or to provide web application functionality.

### IV. Example Remote Network Management Architecture

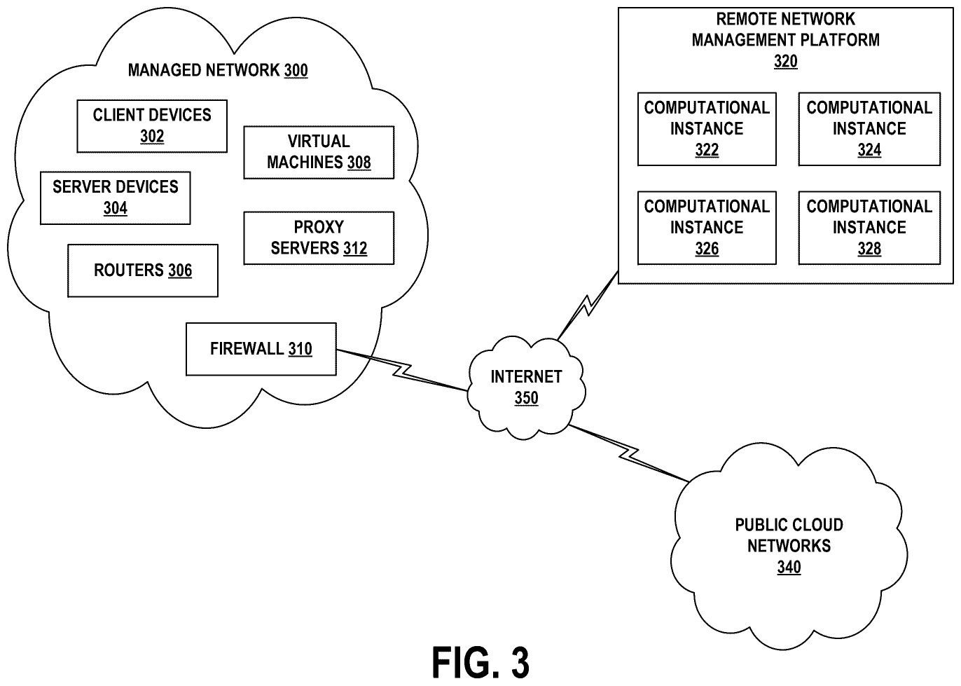

FIG. 3 depicts a remote network management architecture, in accordance with example embodiments. This architecture includes three main components—managed network 300, remote network management platform 320, and public cloud networks 340—all connected by way of Internet 350.

### A. Managed Networks

Managed network 300 may be, for example, an enterprise network used by an entity for computing and communications tasks, as well as storage of data. Thus, managed network 300 may include client devices 302, server devices 304, routers 306, virtual machines 308, firewall 310, and/or proxy servers 312. Client devices 302 may be embodied by computing device 100, server devices 304 may be embodied by computing device 100 or server cluster 200, and routers 306 may be any type of router, switch, or gateway.

Virtual machines 308 may be embodied by one or more of computing device 100 or server cluster 200. In general, a virtual machine is an emulation of a computing system, and mimics the functionality (e.g., processor, memory, and communication resources) of a physical computer. One physical computing system, such as server cluster 200, may support up to thousands of individual virtual machines. In some embodiments, virtual machines 308 may be managed by a centralized server device or application that facilitates allocation of physical computing resources to individual virtual machines, as well as performance and error reporting. Enterprises often employ virtual machines in order to allocate computing resources in an efficient, as needed fashion. Providers of virtualized computing systems include VMWARE® and MICROSOFT®.

Firewall 310 may be one or more specialized routers or server devices that protect managed network 300 from unauthorized attempts to access the devices, applications, and services therein, while allowing authorized communication that is initiated from managed network 300. Firewall 310 may also provide intrusion detection, web filtering, virus scanning, application-layer gateways, and other applications or services. In some embodiments not shown in FIG. 3, managed network 300 may include one or more virtual private network (VPN) gateways with which it communicates with remote network management platform 320 (see below).

Managed network 300 may also include one or more proxy servers 312. An embodiment of proxy servers 312 may be a server application that facilitates communication and movement of data between managed network 300, remote network management platform 320, and public cloud networks 340. In particular, proxy servers 312 may be able to establish and maintain secure communication sessions with one or more computational instances of remote network management platform 320. By way of such a session, remote network management platform 320 may be able to discover and manage aspects of the architecture and configuration of managed network 300 and its components.

Possibly with the assistance of proxy servers 312, remote network management platform 320 may also be able to discover and manage aspects of public cloud networks 340 that are used by managed network 300. While not shown in FIG. 3, one or more proxy servers 312 may be placed in any of public cloud networks 340 in order to facilitate this discovery and management.

Firewalls, such as firewall 310, typically deny all communication sessions that are incoming by way of Internet 350, unless such a session was ultimately initiated from behind the firewall (i.e., from a device on managed network 300) or the firewall has been explicitly configured to support the session. By placing proxy servers 312 behind firewall 310 (e.g., within managed network 300 and protected by firewall 310), proxy servers 312 may be able to initiate these communication sessions through firewall 310. Thus, firewall 310 might not have to be specifically configured to support incoming sessions from remote network management platform 320, thereby avoiding potential security risks to managed network 300.

In some cases, managed network 300 may consist of a few devices and a small number of networks. In other deployments, managed network 300 may span multiple physical locations and include hundreds of networks and hundreds of thousands of devices. Thus, the architecture depicted in FIG. 3 is capable of scaling up or down by orders of magnitude.

Furthermore, depending on the size, architecture, and connectivity of managed network 300, a varying number of proxy servers 312 may be deployed therein. For example, each one of proxy servers 312 may be responsible for communicating with remote network management platform 320 regarding a portion of managed network 300. Alternatively or additionally, sets of two or more proxy servers may be assigned to such a portion of managed network 300 for purposes of load balancing, redundancy, and/or high availability.

### B. Remote Network Management Platforms

Remote network management platform 320 is a hosted environment that provides aPaaS services to users, particularly to the operator of managed network 300. These services may take the form of web-based portals, for example, using the aforementioned web-based technologies. Thus, a user can securely access remote network management platform 320 from, for example, client devices 302, or potentially from a client device outside of managed network 300. By way of the web-based portals, users may design, test, and deploy applications, generate reports, view analytics, and perform other tasks. Remote network management platform 320 may also be referred to as a multi-application platform.

As shown in FIG. 3, remote network management platform 320 includes four computational instances 322, 324, 326, and 328. Each of these computational instances may represent one or more server nodes operating dedicated copies of the aPaaS software and/or one or more database nodes. The arrangement of server and database nodes on physical server devices and/or virtual machines can be flexible and may vary based on enterprise needs. In combination, these nodes may provide a set of web portals, services, and applications (e.g., a wholly-functioning aPaaS system) available to a particular enterprise. In some cases, a single enterprise may use multiple computational instances.

For example, managed network 300 may be an enterprise customer of remote network management platform 320, and may use computational instances 322, 324, and 326. The reason for providing multiple computational instances to one customer is that the customer may wish to independently develop, test, and deploy its applications and services. Thus, computational instance 322 may be dedicated to application development related to managed network 300, computational instance 324 may be dedicated to testing these applications, and computational instance 326 may be dedicated to the live operation of tested applications and services. A computational instance may also be referred to as a hosted instance, a remote instance, a customer instance, or by some other designation. Any application deployed onto a computational instance may be a scoped application, in that its access to databases within the computational instance can be restricted to certain elements therein (e.g., one or more particular database tables or particular rows within one or more database tables).

For purposes of clarity, the disclosure herein refers to the arrangement of application nodes, database nodes, aPaaS software executing thereon, and underlying hardware as a “computational instance.” Note that users may colloquially refer to the graphical user interfaces provided thereby as “instances.” But unless it is defined otherwise herein, a “computational instance” is a computing system disposed within remote network management platform 320.

The multi-instance architecture of remote network management platform 320 is in contrast to conventional multi-tenant architectures, over which multi-instance architectures exhibit several advantages. In multi-tenant architectures, data from different customers (e.g., enterprises) are comingled in a single database. While these customers' data are separate from one another, the separation is enforced by the software that operates the single database. As a consequence, a security breach in this system may affect all customers' data, creating additional risk, especially for entities subject to governmental, healthcare, and/or financial regulation. Furthermore, any database operations that affect one customer will likely affect all customers sharing that database. Thus, if there is an outage due to hardware or software errors, this outage affects all such customers. Likewise, if the database is to be upgraded to meet the needs of one customer, it will be unavailable to all customers during the upgrade process. Often, such maintenance windows will be long, due to the size of the shared database.

In contrast, the multi-instance architecture provides each customer with its own database in a dedicated computing instance. This prevents comingling of customer data, and allows each instance to be independently managed. For example, when one customer's instance experiences an outage due to errors or an upgrade, other computational instances are not impacted. Maintenance down time is limited because the database only contains one customer's data. Further, the simpler design of the multi-instance architecture allows redundant copies of each customer database and instance to be deployed in a geographically diverse fashion. This facilitates high availability, where the live version of the customer's instance can be moved when faults are detected or maintenance is being performed.

In some embodiments, remote network management platform 320 may include one or more central instances, controlled by the entity that operates this platform. Like a computational instance, a central instance may include some number of application and database nodes disposed upon some number of physical server devices or virtual machines. Such a central instance may serve as a repository for specific configurations of computational instances as well as data that can be shared amongst at least some of the computational instances. For instance, definitions of common security threats that could occur on the computational instances, software packages that are commonly discovered on the computational instances, and/or an application store for applications that can be deployed to the computational instances may reside in a central instance. Computational instances may communicate with central instances by way of well-defined interfaces in order to obtain this data.

In order to support multiple computational instances in an efficient fashion, remote network management platform 320 may implement a plurality of these instances on a single hardware platform. For example, when the aPaaS system is implemented on a server cluster such as server cluster 200, it may operate virtual machines that dedicate varying amounts of computational, storage, and communication resources to instances. But full virtualization of server cluster 200 might not be necessary, and other mechanisms may be used to separate instances. In some examples, each instance may have a dedicated account and one or more dedicated databases on server cluster 200. Alternatively, a computational instance such as computational instance 322 may span multiple physical devices.

In some cases, a single server cluster of remote network management platform 320 may support multiple independent enterprises. Furthermore, as described below, remote network management platform 320 may include multiple server clusters deployed in geographically diverse data centers in order to facilitate load balancing, redundancy, and/or high availability.

### C. Public Cloud Networks

Public cloud networks 340 may be remote server devices (e.g., a plurality of server clusters such as server cluster 200) that can be used for outsourced computation, data storage, communication, and service hosting operations. These servers may be virtualized (i.e., the servers may be virtual machines). Examples of public cloud networks 340 may include Amazon AWS Cloud, Microsoft Azure Cloud (Azure), Google Cloud Platform (GCP), and IBM Cloud Platform. Like remote network management platform 320, multiple server clusters supporting public cloud networks 340 may be deployed at geographically diverse locations for purposes of load balancing, redundancy, and/or high availability.

Managed network 300 may use one or more of public cloud networks 340 to deploy applications and services to its clients and customers. For instance, if managed network 300 provides online music streaming services, public cloud networks 340 may store the music files and provide web interface and streaming capabilities. In this way, the enterprise of managed network 300 does not have to build and maintain its own servers for these operations.

Remote network management platform 320 may include modules that integrate with public cloud networks 340 to expose virtual machines and managed services therein to managed network 300. The modules may allow users to request virtual resources, discover allocated resources, and provide flexible reporting for public cloud networks 340. In order to establish this functionality, a user from managed network 300 might first establish an account with public cloud networks 340, and request a set of associated resources. Then, the user may enter the account information into the appropriate modules of remote network management platform 320. These modules may then automatically discover the manageable resources in the account, and also provide reports related to usage, performance, and billing.

### D. Communication Support and Other Operations

Internet 350 may represent a portion of the global Internet. However, Internet 350 may alternatively represent a different type of network, such as a private wide-area or local-area packet-switched network.

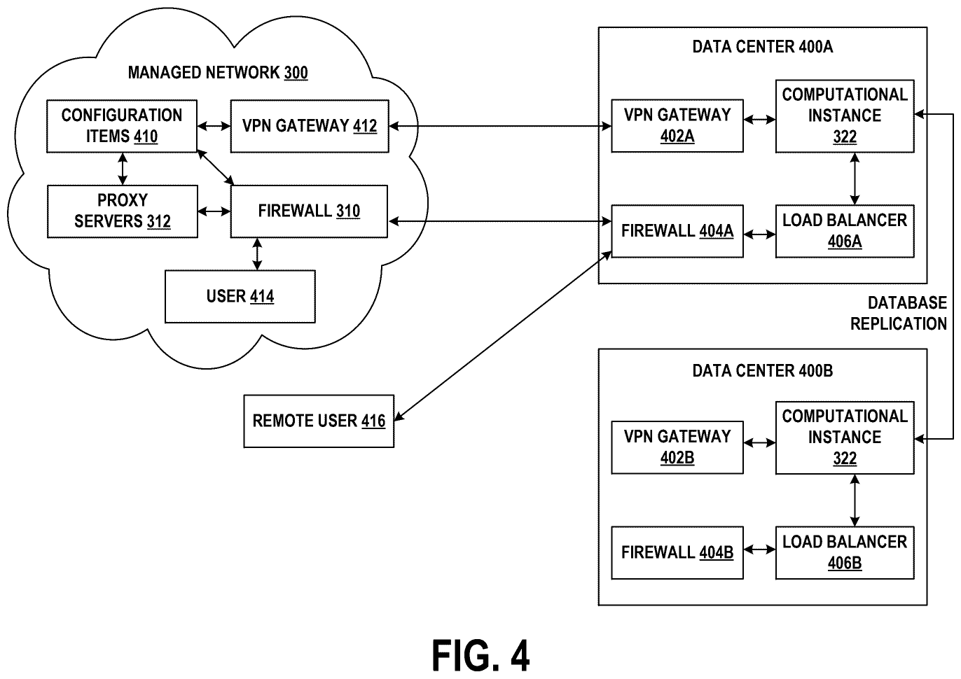

FIG. 4 further illustrates the communication environment between managed network 300 and computational instance 322, and introduces additional features and alternative embodiments. In FIG. 4, computational instance 322 is replicated, in whole or in part, across data centers 400A and 400B. These data centers may be geographically distant from one another, perhaps in different cities or different countries. Each data center includes support equipment that facilitates communication with managed network 300, as well as remote users.

In data center 400A, network traffic to and from external devices flows either through VPN gateway 402A or firewall 404A. VPN gateway 402A may be peered with VPN gateway 412 of managed network 300 by way of a security protocol such as Internet Protocol Security (IPSEC) or Transport Layer Security (TLS). Firewall 404A may be configured to allow access from authorized users, such as user 414 and remote user 416, and to deny access to unauthorized users. By way of firewall 404A, these users may access computational instance 322, and possibly other computational instances. Load balancer 406A may be used to distribute traffic amongst one or more physical or virtual server devices that host computational instance 322. Load balancer 406A may simplify user access by hiding the internal configuration of data center 400A, (e.g., computational instance 322) from client devices. For instance, if computational instance 322 includes multiple physical or virtual computing devices that share access to multiple databases, load balancer 406A may distribute network traffic and processing tasks across these computing devices and databases so that no one computing device or database is significantly busier than the others. In some embodiments, computational instance 322 may include VPN gateway 402A, firewall 404A, and load balancer 406A.

Data center 400B may include its own versions of the components in data center 400A. Thus, VPN gateway 402B, firewall 404B, and load balancer 406B may perform the same or similar operations as VPN gateway 402A, firewall 404A, and load balancer 406A, respectively. Further, by way of real-time or near-real-time database replication and/or other operations, computational instance 322 may exist simultaneously in data centers 400A and 400B.

Data centers 400A and 400B as shown in FIG. 4 may facilitate redundancy and high availability. In the configuration of FIG. 4, data center 400A is active and data center 400B is passive. Thus, data center 400A is serving all traffic to and from managed network 300, while the version of computational instance 322 in data center 400B is being updated in near-real-time. Other configurations, such as one in which both data centers are active, may be supported.

Should data center 400A fail in some fashion or otherwise become unavailable to users, data center 400B can take over as the active data center. For example, domain name system (DNS) servers that associate a domain name of computational instance 322 with one or more Internet Protocol (IP) addresses of data center 400A may re-associate the domain name with one or more IP addresses of data center 400B. After this re-association completes (which may take less than one second or several seconds), users may access computational instance 322 by way of data center 400B.

FIG. 4 also illustrates a possible configuration of managed network 300. As noted above, proxy servers 312 and user 414 may access computational instance 322 through firewall 310. Proxy servers 312 may also access configuration items 410. In FIG. 4, configuration items 410 may refer to any or all of client devices 302, server devices 304, routers 306, and virtual machines 308, any components thereof, any applications or services executing thereon, as well as relationships between devices, components, applications, and services. Thus, the term “configuration items” may be shorthand for part of all of any physical or virtual device, or any application or service remotely discoverable or managed by computational instance 322, or relationships between discovered devices, applications, and services. Configuration items may be represented in a configuration management database (CMDB) of computational instance 322.

As stored or transmitted, a configuration item may be a list of attributes that characterize the hardware or software that the configuration item represents. These attributes may include manufacturer, vendor, location, owner, unique identifier, description, network address, operational status, serial number, time of last update, and so on. The class of a configuration item may determine which subset of attributes are present for the configuration item (e.g., software and hardware configuration items may have different lists of attributes).

As noted above, VPN gateway 412 may provide a dedicated VPN to VPN gateway 402A. Such a VPN may be helpful when there is a significant amount of traffic between managed network 300 and computational instance 322, or security policies otherwise suggest or require use of a VPN between these sites. In some embodiments, any device in managed network 300 and/or computational instance 322 that directly communicates via the VPN is assigned a public IP address. Other devices in managed network 300 and/or computational instance 322 may be assigned private IP addresses (e.g., IP addresses selected from the 10.0.0.0-10.255.255.255 or 192.168.0.0-192.168.255.255 ranges, represented in shorthand as subnets 10.0.0.0/8 and 192.168.0.0/16, respectively). In various alternatives, devices in managed network 300, such as proxy servers 312, may use a secure protocol (e.g., TLS) to communicate directly with one or more data centers.

### V. Example Discovery

In order for remote network management platform 320 to administer the devices, applications, and services of managed network 300, remote network management platform 320 may first determine what devices are present in managed network 300, the configurations, constituent components, and operational statuses of these devices, and the applications and services provided by the devices. Remote network management platform 320 may also determine the relationships between discovered devices, their components, applications, and services. Representations of these devices, components, applications, and services may be referred to as configuration items.

The process of determining the configuration items and relationships therebetween within managed network 300 is referred to as discovery, and may be facilitated at least in part by proxy servers 312. To that point, proxy servers 312 may relay discovery requests and responses between managed network 300 and remote network management platform 320.

Configuration items and relationships may be stored in a CMDB and/or other locations. Further, configuration items may be of various classes that define their constituent attributes and that exhibit an inheritance structure not unlike object-oriented software modules. For instance, a configuration item class of “server” may inherit all attributes from a configuration item class of “hardware” and also include further server-specific attributes. Likewise, a configuration item class of “LINUX® server” may inherit all attributes from the configuration item class of “server” and also include further LINUX®-specific attributes. Additionally, configuration items may represent other components, such as services, data center infrastructure, software licenses, units of source code, configuration files, and documents.

While this section describes discovery conducted on managed network 300, the same or similar discovery procedures may be used on public cloud networks 340. Thus, in some environments, “discovery” may refer to discovering configuration items and relationships on a managed network and/or one or more public cloud networks.

For purposes of the embodiments herein, an “application” may refer to one or more processes, threads, programs, client software modules, server software modules, or any other software that executes on a device or group of devices. A “service” may refer to a high-level capability provided by one or more applications executing on one or more devices working in conjunction with one another. For example, a web service may involve multiple web application server threads executing on one device and accessing information from a database application that executes on another device.

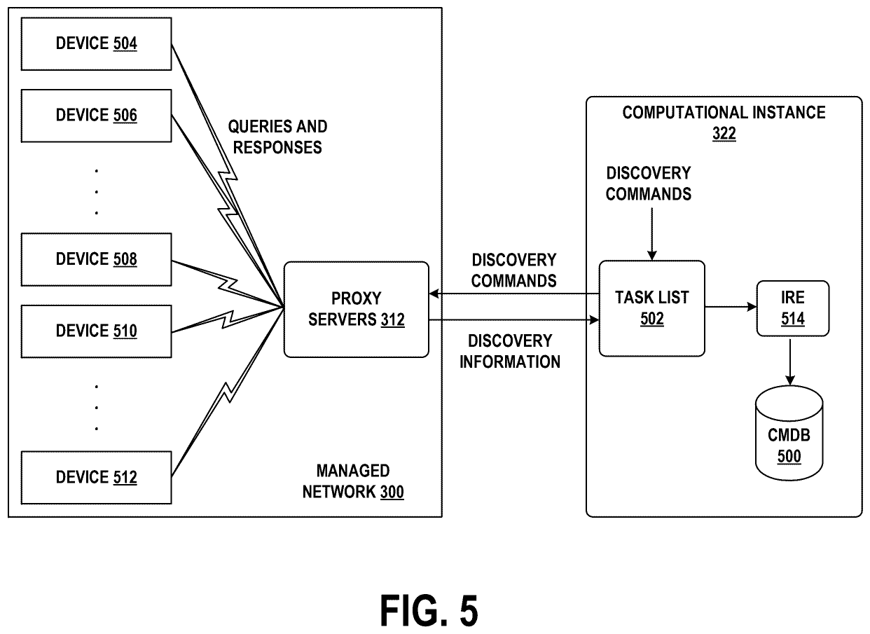

FIG. 5 provides a logical depiction of how configuration items and relationships can be discovered, as well as how information related thereto can be stored. For sake of simplicity, remote network management platform 320, public cloud networks 340, and Internet 350 are not shown.

In FIG. 5, CMDB 500, task list 502, and identification and reconciliation engine (IRE) 514 are disposed and/or operate within computational instance 322. Task list 502 represents a connection point between computational instance 322 and proxy servers 312. Task list 502 may be referred to as a queue, or more particularly as an external communication channel (ECC) queue. Task list 502 may represent not only the queue itself but any associated processing, such as adding, removing, and/or manipulating information in the queue.

As discovery takes place, computational instance 322 may store discovery tasks (jobs) that proxy servers 312 are to perform in task list 502, until proxy servers 312 request these tasks in batches of one or more. Placing the tasks in task list 502 may trigger or otherwise cause proxy servers 312 to begin their discovery operations. For example, proxy servers 312 may poll task list 502 periodically or from time to time, or may be notified of discovery commands in task list 502 in some other fashion. Alternatively or additionally, discovery may be manually triggered or automatically triggered based on triggering events (e.g., discovery may automatically begin once per day at a particular time).

Regardless, computational instance 322 may transmit these discovery commands to proxy servers 312 upon request. For example, proxy servers 312 may repeatedly query task list 502, obtain the next task therein, and perform this task until task list 502 is empty or another stopping condition has been reached. In response to receiving a discovery command, proxy servers 312 may query various devices, components, applications, and/or services in managed network 300 (represented for sake of simplicity in FIG. 5 by devices 504, 506, 508, 510, and 512). These devices, components, applications, and/or services may provide responses relating to their configuration, operation, and/or status to proxy servers 312. In turn, proxy servers 312 may then provide this discovered information to task list 502 (i.e., task list 502 may have an outgoing queue for holding discovery commands until requested by proxy servers 312 as well as an incoming queue for holding the discovery information until it is read).

IRE 514 may be a software module that removes discovery information from task list 502 and formulates this discovery information into configuration items (e.g., representing devices, components, applications, and/or services discovered on managed network 300) as well as relationships therebetween. Then, IRE 514 may provide these configuration items and relationships to CMDB 500 for storage therein. The operation of IRE 514 is described in more detail below.

In this fashion, configuration items stored in CMDB 500 represent the environment of managed network 300. As an example, these configuration items may represent a set of physical and/or virtual devices (e.g., client devices, server devices, routers, or virtual machines), applications executing thereon (e.g., web servers, email servers, databases, or storage arrays), as well as services that involve multiple individual configuration items. Relationships may be pairwise definitions of arrangements or dependencies between configuration items.

In order for discovery to take place in the manner described above, proxy servers 312, CMDB 500, and/or one or more credential stores may be configured with credentials for the devices to be discovered. Credentials may include any type of information needed in order to access the devices. These may include userid/password pairs, certificates, and so on. In some embodiments, these credentials may be stored in encrypted fields of CMDB 500. Proxy servers 312 may contain the decryption key for the credentials so that proxy servers 312 can use these credentials to log on to or otherwise access devices being discovered.

There are two general types of discovery-horizontal and vertical (top-down). Each are discussed below.

### A. Horizontal Discovery

Horizontal discovery is used to scan managed network 300, find devices, components, and/or applications, and then populate CMDB 500 with configuration items representing these devices, components, and/or applications. Horizontal discovery also creates relationships between the configuration items. For instance, this could be a “runs on” relationship between a configuration item representing a software application and a configuration item representing a server device on which it executes. Typically, horizontal discovery is not aware of services and does not create relationships between configuration items based on the services in which they operate.

There are two versions of horizontal discovery. One relies on probes and sensors, while the other also employs patterns. Probes and sensors may be scripts (e.g., written in JAVASCRIPT®) that collect and process discovery information on a device and then update CMDB 500 accordingly. More specifically, probes explore or investigate devices on managed network 300, and sensors parse the discovery information returned from the probes.

Patterns are also scripts that collect data on one or more devices, process it, and update the CMDB. Patterns differ from probes and sensors in that they are written in a specific discovery programming language and are used to conduct detailed discovery procedures on specific devices, components, and/or applications that often cannot be reliably discovered (or discovered at all) by more general probes and sensors. Particularly, patterns may specify a series of operations that define how to discover a particular arrangement of devices, components, and/or applications, what credentials to use, and which CMDB tables to populate with configuration items resulting from this discovery.

Both versions may proceed in four logical phases: scanning, classification, identification, and exploration. Also, both versions may require specification of one or more ranges of IP addresses on managed network 300 for which discovery is to take place. Each phase may involve communication between devices on managed network 300 and proxy servers 312, as well as between proxy servers 312 and task list 502. Some phases may involve storing partial or preliminary configuration items in CMDB 500, which may be updated in a later phase.

In the scanning phase, proxy servers 312 may probe each IP address in the specified range(s) of IP addresses for open Transmission Control Protocol (TCP) and/or User Datagram Protocol (UDP) ports to determine the general type of device and its operating system. The presence of such open ports at an IP address may indicate that a particular application is operating on the device that is assigned the IP address, which in turn may identify the operating system used by the device. For example, if TCP port 135 is open, then the device is likely executing a WINDOWS® operating system. Similarly, if TCP port 22 is open, then the device is likely executing a UNIX® operating system, such as LINUX®. If UDP port 161 is open, then the device may be able to be further identified through the Simple Network Management Protocol (SNMP). Other possibilities exist.

In the classification phase, proxy servers 312 may further probe each discovered device to determine the type of its operating system. The probes used for a particular device are based on information gathered about the devices during the scanning phase. For example, if a device is found with TCP port 22 open, a set of UNIX®-specific probes may be used. Likewise, if a device is found with TCP port 135 open, a set of WINDOWS®-specific probes may be used. For either case, an appropriate set of tasks may be placed in task list 502 for proxy servers 312 to carry out. These tasks may result in proxy servers 312 logging on, or otherwise accessing information from the particular device. For instance, if TCP port 22 is open, proxy servers 312 may be instructed to initiate a Secure Shell (SSH) connection to the particular device and obtain information about the specific type of operating system thereon from particular locations in the file system. Based on this information, the operating system may be determined. As an example, a UNIX® device with TCP port 22 open may be classified as AIX®, HPUX, LINUX®, MACOS®, or SOLARIS®. This classification information may be stored as one or more configuration items in CMDB 500.

In the identification phase, proxy servers 312 may determine specific details about a classified device. The probes used during this phase may be based on information gathered about the particular devices during the classification phase. For example, if a device was classified as LINUX®, a set of LINUX®-specific probes may be used. Likewise, if a device was classified as WINDOWS® 10, as a set of WINDOWS®-10-specific probes may be used. As was the case for the classification phase, an appropriate set of tasks may be placed in task list 502 for proxy servers 312 to carry out. These tasks may result in proxy servers 312 reading information from the particular device, such as basic input/output system (BIOS) information, serial numbers, network interface information, media access control address(es) assigned to these network interface(s), IP address(es) used by the particular device and so on. This identification information may be stored as one or more configuration items in CMDB 500 along with any relevant relationships therebetween. Doing so may involve passing the identification information through IRE 514 to avoid generation of duplicate configuration items, for purposes of disambiguation, and/or to determine the table(s) of CMDB 500 in which the discovery information should be written.

In the exploration phase, proxy servers 312 may determine further details about the operational state of a classified device. The probes used during this phase may be based on information gathered about the particular devices during the classification phase and/or the identification phase. Again, an appropriate set of tasks may be placed in task list 502 for proxy servers 312 to carry out. These tasks may result in proxy servers 312 reading additional information from the particular device, such as processor information, memory information, lists of running processes (software applications), and so on. Once more, the discovered information may be stored as one or more configuration items in CMDB 500, as well as relationships.

Running horizontal discovery on certain devices, such as switches and routers, may utilize SNMP. Instead of or in addition to determining a list of running processes or other application-related information, discovery may determine additional subnets known to a router and the operational state of the router's network interfaces (e.g., active, inactive, queue length, number of packets dropped, etc.). The IP addresses of the additional subnets may be candidates for further discovery procedures. Thus, horizontal discovery may progress iteratively or recursively.

Patterns are used only during the identification and exploration phases-under pattern-based discovery, the scanning and classification phases operate as they would if probes and sensors are used. After the classification stage completes, a pattern probe is specified as a probe to use during identification. Then, the pattern probe and the pattern that it specifies are launched.

Patterns support a number of features, by way of the discovery programming language, that are not available or difficult to achieve with discovery using probes and sensors. For example, discovery of devices, components, and/or applications in public cloud networks, as well as configuration file tracking, is much simpler to achieve using pattern-based discovery. Further, these patterns are more easily customized by users than probes and sensors. Additionally, patterns are more focused on specific devices, components, and/or applications and therefore may execute faster than the more general approaches used by probes and sensors.

Once horizontal discovery completes, a configuration item representation of each discovered device, component, and/or application is available in CMDB 500. For example, after discovery, operating system version, hardware configuration, and network configuration details for client devices, server devices, and routers in managed network 300, as well as applications executing thereon, may be stored as configuration items. This collected information may be presented to a user in various ways to allow the user to view the hardware composition and operational status of devices.

Furthermore, CMDB 500 may include entries regarding the relationships between configuration items. More specifically, suppose that a server device includes a number of hardware components (e.g., processors, memory, network interfaces, storage, and file systems), and has several software applications installed or executing thereon. Relationships between the components and the server device (e.g., “contained by” relationships) and relationships between the software applications and the server device (e.g., “runs on” relationships) may be represented as such in CMDB 500.

More generally, the relationship between a software configuration item installed or executing on a hardware configuration item may take various forms, such as “is hosted on”, “runs on”, or “depends on”. Thus, a database application installed on a server device may have the relationship “is hosted on” with the server device to indicate that the database application is hosted on the server device. In some embodiments, the server device may have a reciprocal relationship of “used by” with the database application to indicate that the server device is used by the database application. These relationships may be automatically found using the discovery procedures described above, though it is possible to manually set relationships as well.

In this manner, remote network management platform 320 may discover and inventory the hardware and software deployed on and provided by managed network 300.

### B. Vertical Discovery

Vertical discovery is a technique used to find and map configuration items that are part of an overall service, such as a web service. For example, vertical discovery can map a web service by showing the relationships between a web server application, a LINUX® server device, and a database that stores the data for the web service. Typically, horizontal discovery is run first to find configuration items and basic relationships therebetween, and then vertical discovery is run to establish the relationships between configuration items that make up a service.

Patterns can be used to discover certain types of services, as these patterns can be programmed to look for specific arrangements of hardware and software that fit a description of how the service is deployed. Alternatively or additionally, traffic analysis (e.g., examining network traffic between devices) can be used to facilitate vertical discovery. In some cases, the parameters of a service can be manually configured to assist vertical discovery.

In general, vertical discovery seeks to find specific types of relationships between devices, components, and/or applications. Some of these relationships may be inferred from configuration files. For example, the configuration file of a web server application can refer to the IP address and port number of a database on which it relies. Vertical discovery patterns can be programmed to look for such references and infer relationships therefrom. Relationships can also be inferred from traffic between devices—for instance, if there is a large extent of web traffic (e.g., TCP port 80 or 8080) traveling between a load balancer and a device hosting a web server, then the load balancer and the web server may have a relationship.

Relationships found by vertical discovery may take various forms. As an example, an email service may include an email server software configuration item and a database application software configuration item, each installed on different hardware device configuration items. The email service may have a “depends on” relationship with both of these software configuration items, while the software configuration items have a “used by” reciprocal relationship with the email service. Such services might not be able to be fully determined by horizontal discovery procedures, and instead may rely on vertical discovery and possibly some extent of manual configuration.

### C. Advantages of Discovery

Regardless of how discovery information is obtained, it can be valuable for the operation of a managed network. Notably, IT personnel can quickly determine where certain software applications are deployed, and what configuration items make up a service. This allows for rapid pinpointing of root causes of service outages or degradation. For example, if two different services are suffering from slow response times, the CMDB can be queried (perhaps among other activities) to determine that the root cause is a database application that is used by both services having high processor utilization. Thus, IT personnel can address the database application rather than waste time considering the health and performance of other configuration items that make up the services.

In another example, suppose that a database application is executing on a server device, and that this database application is used by an employee onboarding service as well as a payroll service. Thus, if the server device is taken out of operation for maintenance, it is clear that the employee onboarding service and payroll service will be impacted. Likewise, the dependencies and relationships between configuration items may be able to represent the services impacted when a particular hardware device fails.

In general, configuration items and/or relationships between configuration items may be displayed on a web-based interface and represented in a hierarchical fashion. Modifications to such configuration items and/or relationships in the CMDB may be accomplished by way of this interface.

Furthermore, users from managed network 300 may develop workflows that allow certain coordinated activities to take place across multiple discovered devices. For instance, an IT workflow might allow the user to change the common administrator password to all discovered LINUX® devices in a single operation.

### VI. CMDB Identification Rules and Reconciliation

A CMDB, such as CMDB 500, provides a repository of configuration items and relationships. When properly provisioned, it can take on a key role in higher-layer applications deployed within or involving a computational instance. These applications may relate to enterprise IT service management, operations management, asset management, configuration management, compliance, and so on.

For example, an IT service management application may use information in the CMDB to determine applications and services that may be impacted by a component (e.g., a server device) that has malfunctioned, crashed, or is heavily loaded. Likewise, an asset management application may use information in the CMDB to determine which hardware and/or software components are being used to support particular enterprise applications. As a consequence of the importance of the CMDB, it is desirable for the information stored therein to be accurate, consistent, and up to date.

A CMDB may be populated in various ways. As discussed above, a discovery procedure may automatically store information including configuration items and relationships in the CMDB. However, a CMDB can also be populated, as a whole or in part, by manual entry, configuration files, and third-party data sources. Given that multiple data sources may be able to update the CMDB at any time, it is possible that one data source may overwrite entries of another data source. Also, two data sources may each create slightly different entries for the same configuration item, resulting in a CMDB containing duplicate data. When either of these occurrences takes place, they can cause the health and utility of the CMDB to be reduced.

In order to mitigate this situation, these data sources might not write configuration items directly to the CMDB. Instead, they may write to an identification and reconciliation application programming interface (API) of IRE 514. Then, IRE 514 may use a set of configurable identification rules to uniquely identify configuration items and determine whether and how they are to be written to the CMDB.

In general, an identification rule specifies a set of configuration item attributes that can be used for this unique identification. Identification rules may also have priorities so that rules with higher priorities are considered before rules with lower priorities. Additionally, a rule may be independent, in that the rule identifies configuration items independently of other configuration items. Alternatively, the rule may be dependent, in that the rule first uses a metadata rule to identify a dependent configuration item.

Metadata rules describe which other configuration items are contained within a particular configuration item, or the host on which a particular configuration item is deployed. For example, a network directory service configuration item may contain a domain controller configuration item, while a web server application configuration item may be hosted on a server device configuration item.

A goal of each identification rule is to use a combination of attributes that can unambiguously distinguish a configuration item from all other configuration items, and is expected not to change during the lifetime of the configuration item. Some possible attributes for an example server device may include serial number, location, operating system, operating system version, memory capacity, and so on. If a rule specifies attributes that do not uniquely identify the configuration item, then multiple components may be represented as the same configuration item in the CMDB. Also, if a rule specifies attributes that change for a particular configuration item, duplicate configuration items may be created.

Thus, when a data source provides information regarding a configuration item to IRE 514, IRE 514 may attempt to match the information with one or more rules. If a match is found, the configuration item is written to the CMDB or updated if it already exists within the CMDB. If a match is not found, the configuration item may be held for further analysis.

Configuration item reconciliation procedures may be used to ensure that only authoritative data sources are allowed to overwrite configuration item data in the CMDB. This reconciliation may also be rules-based. For instance, a reconciliation rule may specify that a particular data source is authoritative for a particular configuration item type and set of attributes. Then, IRE 514 might only permit this authoritative data source to write to the particular configuration item, and writes from unauthorized data sources may be prevented. Thus, the authorized data source becomes the single source of truth regarding the particular configuration item. In some cases, an unauthorized data source may be allowed to write to a configuration item if it is creating the configuration item or the attributes to which it is writing are empty.

Additionally, multiple data sources may be authoritative for the same configuration item or attributes thereof. To avoid ambiguities, these data sources may be assigned precedences that are taken into account during the writing of configuration items. For example, a secondary authorized data source may be able to write to a configuration item's attribute until a primary authorized data source writes to this attribute. Afterward, further writes to the attribute by the secondary authorized data source may be prevented.

In some cases, duplicate configuration items may be automatically detected by IRE 514 or in another fashion. These configuration items may be deleted or flagged for manual de-duplication.

### VII. Example Prompt Tuning Pipelines

Large language models or other generative trained machine learning models generate outputs from input textual prompts. These prompts can include queries, context information, examples, instructions regarding the formatting or other aspects of the form of the model output, or other information in order to result in generation of a desired output. Larger models generally produce better outputs with respect to quality, accuracy, and satisfaction of and/or adherence to prompt instructions. Additionally, the parameters and structure of such larger models generally represent a greater breadth and depth of ‘knowledge’ that is available to generate the outputs. However, larger models are also associated with higher computational and other costs. For example, performing inference using a larger model implicates increased memory requirements (e.g., to store the greater number of parameters of a larger model), computational cycle and power requirements (e.g., to execute additional multiplications, additions, or other computational tasks related to the increased number of parameters, layers, or other elements of a larger model), bandwidth requirements (e.g., related to transmitting intermediate results between processors, GPUs, or other elements of a computational system being used to execute the model), or other costs that are increased by the use of larger, rather than smaller, models. The computational and other costs of training and/or fine-tuning such models is also greatly increased, including increased requirements regarding the amount and quality of training data used to train such larger models.

In contrast, smaller models are less expensive to execute. However, this benefit generally comes at the cost of decreased output accuracy, including decreased adherence to formatting instructions or other constraints instructed in the input regarding the contents and form of the output, and a decreased amount of ‘knowledge’ about various tasks. To compensate for these shortcomings, such smaller models can be fine-tuned or otherwise retrained to increase their ability to perform specific tasks. However, such training requires large amounts of task-specific training data, increasing the power, storage, and other computational costs to obtain and keep such training data. Additionally, such a training process is very expensive with respect to processor cycles, power, memory use, bandwidth (e.g., between different GPUs, processors, servers, or other computational elements performing aspects of the training in parallel), or other computational costs.

The embodiments described herein allow smaller, less costly-to-execute models to be used to accomplish various specified tasks at higher accuracy and quality without fine-tuning or otherwise retraining the smaller model on the specified task(s). This is accomplished by generating a prompt that is specific to the target task and to the capabilities of the smaller model, which includes elements (e.g., discrete prompt segments) to provide context, supplemental instruction, or other information to make up for aspects of the task at which the smaller model is less competent. For example, the model-specific prompt include an instruction to accomplish the target task while also providing an amount of contextual information that is specifically tailored to the smaller model, including additional prompt contents for aspects of the task with which the smaller model is ‘unfamiliar.’

Such a model-specific prompt can be generated in a variety of ways. For example, the smaller model could be provided with one or more queries relating to the performance of the target tasks and the smaller model's responses to the queries then used to assess the level of competence of the smaller model with respect to various aspects of the task, expanding the prompt to include additional content relating to those aspects of the task that the smaller model for which the model's responses exhibit more errors are for which the smaller model is otherwise less competent. This assessment and/or the generation of the prompt (or segments thereof) may be performed using a larger model that is assumed to have a greater knowledge base or to otherwise have grater competence with respect to the target task. For example, the larger model could be provided with a prompt that includes the smaller model's response(s) (and optionally the corresponding queries, aspects of the instructions or other prompt contents presented to the smaller model, corresponding “model answers,” etc.) and also an instruction to identify sub-portion(s) of one or more of the queries that the smaller model was not competent to process and to responsively add prompt segments to compensate for the identified incompetencies. The prompt can then be input to the smaller model in order to perform the task in an improved manner (e.g., with an accuracy similar to that obtained by using a larger model) while using the reduced amount of memory, processor cycles, power, or other computational costs of executing the smaller model relative to a larger model.

Generating a model-specific prompt can include traversing a graph or similar structure to assemble the prompt in a step-wise fashion. At each node or other decision point in the structure, a corresponding query is posed as input to the smaller model to assess whether the smaller model is ‘competent’ with respect to knowledge or context that is relevant to the task. The smaller model's response is then assessed (e.g., by application to a larger model and/or by comparison to a ‘model answer’ that is also associated with the applied query) to determine whether the smaller model is competent with respect to the topic of the query. This can include determining an error threshold (e.g., an accuracy score, a competence score) that is then compared to a threshold in order to determine whether the smaller model is competent (or not). If the smaller model is not competent, a corresponding segment is added to the prompt being assembled (e.g., to provide instructions, an example, or some other information to assist the smaller model in performing the task by augmenting the smaller model's ‘knowledge’ of a corresponding topic relevant to the task). Once the graph has been traversed, the completed prompt can be input to the smaller model in order to perform the task in an improved manner (e.g., with an accuracy similar to that obtained by using a larger model) while using the reduced amount of memory, processor cycles, power, or other computational costs of executing the smaller model relative to a larger model. In some examples, one or more of the nodes of the graph could have two different prompt segments to add to the model-specific prompt, one to be added if the model is judged competent, and the other to be added if the model is judged incompetent. In some examples, the graph could be a simple sequence of queries (and associated prompt segments) that are each assessed in turn (i.e., the ‘graph’ could be a simple, non-branching set of nodes wherein each node is traversed regardless of the result of any other node); alternatively, the graph could have a more complex structure such that the result of some nodes could determine whether other nodes (and their corresponding queries) are assessed at all.

Note that a model-specific prompt as described herein can include, in addition to various added prompt segments or other additions or modifications related to the specific competencies of a model with respect to aspects of a target task, baseline elements related to a core instruction to perform the target task, incident-specific variable contents relating to a specific performance of the task (e.g., the contents of a text to be summarized, when the target task is text summarization), or other common elements. Such common elements can form the initial prompt to which is added various prompt segments as a result of the performance of the various embodiments described herein. The embodiments described herein can be used to generate model-specific prompts to perform a variety of different target tasks, including text summarization, root cause analysis, formatting of unstructured text (e.g., generating incident reports from chat logs), generation of knowledgebase articles from incident reports or other input information, or other tasks.

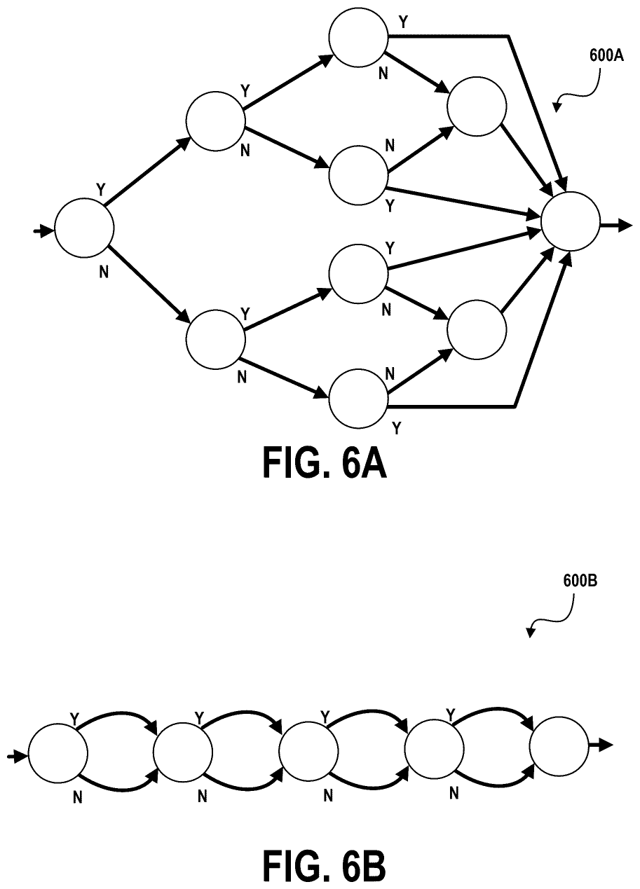

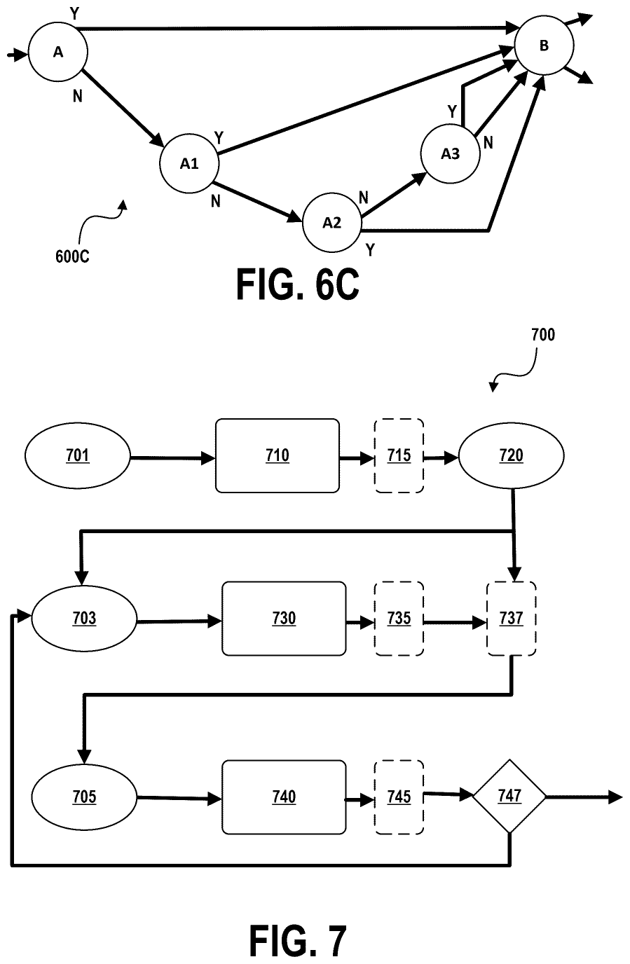

FIG. 6A depicts an example of a graph that could be traversed to generate a model-specific prompt as described herein. As shown, the graph 600A includes a number of nodes that are connected together and that can be traversed to assemble, in a piecewise fashion, a model-specific prompt for a target task. This includes, for each node, providing an associated query to a target model to generate a response. The response is then used to assess whether the target model has competently responded to the query or if the model's response indicates that the target model is incompetent with respect to the topic of the query. This can include applying the response (optionally along with a ‘model answer’ associated with the query) to a larger model (e.g., to generate an accuracy percentage or other quantity that can be compared to an error threshold) to determine whether the response was competent. If the model's response is determined not competent, a corresponding prompt segment is added to the model-specific prompt and the graph is traversed to the corresponding downstream node (along the “N” edge). Alternatively, if the model's response is determined to be competent, the graph is traversed to the corresponding downstream node (along the “Y” edge) and, optionally, an alternative prompt segment is added to the model-specific prompt.

As noted above, in some instances all of the queries in a set of queries could be applied to a target model in sequence to evaluate the target model's competence with respect to respective different aspects of a target task. Such a scenario could be represented as a graph, e.g., as the simple graph 600B depicted in FIG. 6B. When traversing the graph 600B of FIG. 6B, the output edges of each node always point to the same downstream node, such that regardless of the competence of the target model with respect to any of the queries, the sequence of nodes traversed along the graph is the same (though the set of prompt segments added to generate the model-specific prompt will depend on the competence of the target model with respect to the queries).

Such a graph can then be reused to determine model-specific prompts for multiple different models. Such different model-specific prompts can then be used, with their respective different target models, to generate improved outputs. For example, a graph or other prompt-generating structure as described herein can be re-used to generate an updated model-specific prompt after a target model has been fine-tuned, retrained, refactored, optimized, or otherwise updated. Using a graph to generate multiple different model-specific prompts for respective different models having respective different parameter counts, memory footprints, power costs, processor cycle costs, or other inference costs can allow one of the different models to be selected to perform the target task, e.g., to fit within a specified compute budget.

The graph or similar structure, queries and corresponding added prompt segments (and optional ‘correct answers’), and/or other information as described herein for generating model-specific prompts can be generated using a larger, general-purpose model that has a broad base of knowledge and that is competent for a wide variety of tasks. This allows the broad knowledge and competence of the larger model to be ‘distilled’ into the graph or other prompt-generation information, enabling prompts to be quickly and efficiently generated for smaller models (e.g., as more efficient smaller models are developed). Such prompts allow the broad knowledge and competence of the larger model to be selectively provided to smaller models according to the smaller models' specific competences, reducing the size of the generated prompts and increasing the quality of outputs generated by the smaller models without retraining the smaller models. Additionally, since the prompt generation methods described herein selectively add (and optionally remove or otherwise modify) prompt segments to assemble a prompt for a specific model, the prompts generated according to the methods described herein can improve the accuracy of outputs generated by smaller models without being excessively long (e.g., as compared to alternative prompt generation techniques, which might unselectively add all available prompt segments). This can allow such generated prompts to remain within the maximum prompt lengths of smaller models which, having smaller maximum prompt lengths, may also be less computationally expensive to inference. Additionally, avoiding the including of extraneous prompt segments can increase the accuracy of model outputs (e.g., by avoiding biasing the model toward aspects of the task with which the model is already familiar).

A larger model can be instructed to generate queries or other prompt-generation information (e.g., corresponding answers and prompt segments, information about the connection of such queries into a graph structure) by presenting the larger model with a prompt instructing the larger model to do so, and optionally instructing the larger model with respect to formatting of the model output (e.g., to facilitate automated extraction of queries, answers, prompt segments, graph edges, or other information into a database or other structured information storage format). Such a prompt can include instructions to identify a set of sub-tasks within the target task and, for each of the identified sub-tasks, to generate a respective query which, if answered by a smaller model, will demonstrate the smaller model's competence with respect to that sub-task. The prompt to the larger model can also include an instruction to generate, for each of the queries, a respective prompt segment that will instruct a smaller model that is incompetent with respect to the associated sub-task such that the smaller model can perform the sub-task competently. The prompt to the larger model can also include additional instructions. For example, the prompt to the larger model can include instructions to generate, for each of the queries, a respective answer that evidences competence with respect to the associated sub-task (e.g., an answer that correctly responds to the call of the associate query). In another example, the prompt to the larger model can include instructions to list the queries in order of the larger model's familiarity with the sub-tasks associated with the queries. In some examples, the prompt to the larger model can include example instances of the task and correct completions thereof, knowledgebase articles or other contextual information relating to the task, or other information.

In examples wherein the queries are organized into a graph structure, the specifics of the graph structure (e.g., the arrangement of edges between query nodes of the graph) can be determined in a variety of ways. In some examples, the prompt provided to the larger model in order to generate the set of queries can also include an instruction to specify the graph structure between the queries. Additionally or alternatively, the queries and associated information (e.g., prompt segments, model answers, putative graph connections) could be provided to the larger model again along with an instruction to output information indicative of the graph of connections between the queries (e.g., according to a specified format, in order to facilitate automated extraction of the graph information from the model output).

In some examples, the graph generation process could be multi-step. E.g., a first step could include generating a first set of queries (e.g., associated with a first set of sub-tasks) and their pattern of interconnection. A second step could then expand each of the sub-task queries, e.g., by instructing the larger model to identify sub-sub-tasks of a given one of the sub-tasks and inserting nodes for the corresponding queries, prompt segments, etc. downstream of the “incompetent” output edge of the given sub-task. This is illustrated by way of example in FIG. 6C, which includes a portion of a graph 600C that includes a first node “A” associated with a first sub-task and a second node “B” associated with a second sub-task. If a smaller model, when provided with the query of node “A,” provides a response that indicates competence with respect to the first sub-task (e.g., by providing a response that does not satisfy an error threshold), then the graph traversal can proceed to node “B,” providing the smaller model with the query of node “B” and assessing the smaller model's response. If, instead, the smaller model provides a response that indicates incompetence with respect to the first sub-task (e.g., by providing a response that satisfies the error threshold), the portion of the graph that includes nodes “A1,” “A2,” and “A3” can be traversed (in addition to optionally adding, to the model-specific prompt, a prompt segment associated with node “A”). Each of the nodes “A1,” “A2,” and “A3” are associated with respective sub-sub-tasks of the first sub-task, allowing the prompt segment(s) added to the model-specific prompt to be tailored to the specific aspects of the first sub-task at which the smaller model is incompetent.

As described above, a set of queries can be associated with respective nodes of a graph that is traversed in order to determine which of the queries a smaller model can satisfactorily answer and to add a corresponding set of prompt segments to generate a model-specific prompt, based on responses to the queries, to compensate for aspects of a target task for which the smaller model is not competent. Additionally or alternatively, the set of the smaller model's responses to a set of queries can be provided to a larger model in order for the larger model to provide some additional input on the generation of the model-specific prompt. Such a process can allow the larger model to directly iterate on, e.g., prompt segments added to compensate for the smaller model's competences or other aspects of the model-specific prompt being generated. In such an example, the set of queries and the smaller model's responses thereto can act as a targeted investigation of the smaller model's competences that the larger model can then use to determine the competence of the model with respect to specific aspects of each query (e.g., in order to provide corresponding specific modifications to the associated prompt segment of the model-specific prompt). The larger model can also update the set of queries and receive the smaller model's responses to the updated queries in order to, e.g., develop more specific information about the model's competence with respect to specific aspects of the task.

Such an iterative process could proceed until the smaller model's responses exhibit a satisfactory level of accuracy. This could include the larger model generating an estimate of the accuracy of the smaller model's responses (e.g., an overall correct answer percentage, an estimate of the degree to which each response and/or the aggregate response correctly answers the queries/corresponds to model answers) and iterating on the queries, model-specific prompt, and/or other aspects of the iterative assessment process until the smaller model's output satisfies an accuracy threshold. In some examples, the prompt provided to assess the smaller model could include an example of the model-specific prompt being generated to allow the larger model to directly assess the accuracy of the smaller model with respect to the target task when evaluating the model-specific prompt. The prompt provided to the larger model can include the queries or other aspects of prompts provided to the smaller model in order to assess the competence of the smaller model.

FIG. 7 depicts aspects of such a model-specific prompt generation process 700. A larger model 710 is provided with a prompt 701 that includes instructions to generate a set of queries to assess the competence of smaller models with respect to aspects (e.g., sub-tasks) of a target task and associated prompt segments to assist such a smaller model if the smaller is not competent with respect to the topic of the associated query. As noted above, such a prompt 701 can also include context information for the target task (e.g., example correct performances of the task, knowledgebase articles or other information relevant to the target task), instructions to generate model answers for the queries, formatting instructions, instructions to generate information to specify a graph whose nodes are the queries, or other content. The larger model 710 output may then optionally be processed 715 to extract portions thereof (e.g., queries, prompt segments, model answers, graph information) into a task-specific assessment structure 720 (e.g., a graph whose nodes are the queries and prompt segments and that can be traversed to generate a model-specific prompt for a smaller model).

An example of the prompt 701, with special characters and other formatting indication the location of insertion of target task-specific examples, manually-generated initial prompt, or other information, is:

```
  Run the below prompt and give the requested answers:
  When approaching a new task from a zero-shot perspective, it can
be broken down into various sub-tasks, most of which are already known
or have existing solutions. This principle also applies to providing prompts
to language models like GPT-4. By leveraging the knowledge and
understanding of stronger models, we can help weaker models identify and
handle unfamiliar sub- tasks effectively. In zero-shot scenarios, we expect
the model to generate responses without specific fine-tuning on the given
task. By providing high- level instructions, context, and examples, we can
guide the model's response based on its pre- existing knowledge and
understanding of language. Our main goal is to identify the unknown sub-
tasks that weaker models struggle with and incorporate necessary
information into the prompts to improve their performance. Larger models
like GPT-4 can assist in identifying these unknown sub- tasks and provide
a foundation for enhancing weaker models.
  Context Examples section:
  <CONTEXT EXAMPLES START>
  %s
  <CONTEXT EXAMPLES START>
  Original Prompt section:
  <ORIGINAL PROMPT START>
  %s
  <ORIGINAL PROMPT END>
  Important Details section:
  <IMPORTANT DETAILS START>
  %s
  <IMPORTANT DETAILS END>
  JSON Response section:
  Your answers should be in JSON format, with keys representing the
questions and values containing your answers. For each important detail
provided, you should create a corresponding question and explain how you
identified that detail. All answers are in the Context Examples section.
Also include a sentence to be added to the prompt for weaker models in
case they do not answer the same question correctly. Additionally, specify
after which sentence your suggested sentences should be added. If your
suggested sentences already exist in the original prompt, or if similar ones
are present, please modify it accordingly. For example:
  {
  “Which concept or section(s) in the Context
  Examples assist you to find <FIRST IMPORTANT
  DETAIL>?”: {
  “answer”: “your answer concisely in main word(s) used in
prompt_sentence. Just print main words, no sentence.”,
  “prompt_sentence”: “Correct sentence to add to the prompt for
weaker models.”,
  “Should be added after this sentence”: “sentence in Original Prompt
section which prompt_sentence should be added after that.”
  },
  “Which concept or section(s) in the Context Examples assist you to
find <SECOND IMPORTANT
  DETAIL>?”: {
  “answer”: “your answer concisely in main word(s) used in
prompt_sentence. Just print main words, no sentence.”,
  “prompt_sentence”: “Correct sentence to add to the prompt for
weaker models.”,
  “Should be added after this sentence”: “sentence in Original Prompt
section which prompt_sentence should be added after that.”
```

The task-specific assessment structure 720 can then be used to generate a prompt 703 for a smaller model 730 that presents the smaller model 730 with at least the queries of the task-specific assessment structure 720 (e.g., all of the queries at once, queries one at a time according to a pattern of traversal of a graph represented by the task-specific assessment structure 720) and optionally with additional content (e.g., context information relevant to the target task, examples of the task that will be provided to the smaller model as part of a model-specific prompt, instructions regarding the format of the smaller model's output).

An example of such a prompt 703, with special characters and other formatting indication the location of insertion of target task-specific examples, the queries from the task-specific assessment structure 720, or other information, is:

```
  Run the below prompt and give the requested answers:
  When approaching a new task from a zero-shot perspective, it can
be broken down into various sub-tasks, most of which are already known
or have existing solutions. This principle also applies to providing prompts
to language models like GPT-4. By leveraging the knowledge and
understanding of stronger models, we can help weaker models identify and
handle unfamiliar sub- tasks effectively. In zero-shot scenarios, we expect
the model to generate responses without specific fine-tuning on the given
task. By providing high- level instructions, context, and examples, we can
guide the model's response based on its pre- existing knowledge and
understanding of language. Our main goal is to identify the unknown sub-
tasks that weaker models struggle with and incorporate necessary
information into the prompts to improve their performance. Larger models
like GPT-4 can assist in identifying these unknown sub- tasks and provide
a foundation for enhancing weaker models.
  Context Examples section:
  <CONTEXT EXAMPLES START>
  %s
  <CONTEXT EXAMPLES END>
  Original Prompt section:
  <ORIGINAL PROMPT START>
  %s
  <ORIGINAL PROMPT END>
  Questions for GPT-4 section:
  <QUESTIONS FOR GPT-4 START>
  %s
  <QUESTIONS FOR GPT-4 END>
  JSON Response:
  Your answers should be in a JSON format, containing keys as the
actual questions and values as your answers. Additionally, include a
sentence that should be added to the prompt for weaker models in case
they do not answer the same question correctly. If your suggested
sentences already exist in the original prompt, or if similar ones are
present, please modify it accordingly. For example:
  {
  <FIRST FULL QUESTION>: {
  “answer”: “your answer concisely in word(s)”,
  “prompt_sentence”: “Correct sentence to add to the prompt for
weaker models.”
  },
  <SECOND FULL QUESTION>: {
  “answer”: “your answer concisely in word(s)”,
  “prompt_sentence”: “Correct sentence to add to the prompt for
weaker models.”
  }
  }
```

The smaller model's output may then optionally be processed 735 to extract portions thereof (e.g., responses to the queries) and optionally compared 737 to the task-specific assessment structure 720 (e.g., by using the larger model 710 or some other method to compare the smaller model's responses to the model answers to generate an accuracy score or some other score that can be compared to an error threshold). The smaller model's output, the task-specific assessment structure 720, and/or results of the comparison thereof can then be provided to a larger model 740 (e.g., the same larger model 710 used to generate the task-specific assessment structure 720) as a prompt 705 in order to generate a model-specific prompt to assist the smaller model 730 to perform the target task. This can include instructing the larger model 740 to generate an accuracy of the smaller model's responses (in aggregate or individually, optionally relative to answers from the task-specific assessment structure 720), providing instructions regarding formatting of the output (e.g., to facilitate automated extracted of modified prompts, queries, accuracy estimates or other aspects of the output for later use), a list of model answers from the task-specific assessment structure 720, or other instructions or context information.

An example of such a prompt 705, with special characters and other formatting indication the location of insertion of target task-specific examples, the queries from the task-specific assessment structure 720, responses generated by the smaller model 730, the task prompt presented to the smaller model 730, or other information, is:

```
  Run the below prompt and give the requested answers:
  When approaching a new task from a zero-shot perspective, it can
be broken down into various sub-tasks, most of which are already known or have
existing solutions. This principle also applies to providing prompts to language
models like GPT-4. By leveraging the knowledge and understanding of stronger
models, we can help weaker models identify and handle unfamiliar sub- tasks
effectively. In zero- shot scenarios, we expect the model to generate responses
without specific fine-tuning on the given task. By providing high-level
instructions, context, and examples, we can guide the model's response based on
its pre- existing knowledge and understanding of language. Our main goal is to
identify the unknown sub- tasks that weaker models struggle with and incorporate
necessary information into the prompts to improve their performance. Larger
models like GPT-4 can assist in identifying these unknown sub- tasks and provide
a foundation for enhancing weaker models.
  Previously, you have provided the below answers in a json format
containing keys as the actual questions and values as your answers.
  %s
  As per your suggestion, some modifications have been applied, and
the modified prompt below has been given to a weaker model.
  Modified Prompt section:
  <MODIFIED PROMPT START>
  %s
  <MODIFIED PROMPT END>
  - The modified prompt, along with the content shown below, is
provided to a weaker model like Mixtral and also gpt. The input and output for %d
examples for both Mixtral and gpt are displayed below:
  Model Context Examples section:
  <MODEL CONTEXT EXAMPLES START>
  %s
  <MODEL CONTEXT EXAMPLES END>
  Please review the inputs in the Model Context Examples provided
in the <MODEL INPUT> section one by one and compare the weak model results
in the <WEAK MODEL RESPONSE> sections with the results given by GPT in
the <GPT MODEL RESPONSE> sections. If the average accuracy percentage for
comparison results is less than %d%%, identify the problem areas, recommend
techniques to fine-tune the modified prompt, specify which sentence(s) should be
added, and indicate where they should be added. Provide all this information in
JSON format. If the average accuracy percentage is more than %d%%, set all
answers to N/A. The average accuracy percentage between GPT and the weak
model results can be calculated by treating GPT's outputs as the benchmark and
comparing weak model's outputs against them. Calculation should be for each
keys and values separately.
  JSON Response:
  Your answers should be in a JSON format like below:
  {
  <Average accuracy>: {
  “percentage”: “average accuracy percentage between mixtral and
gpt response”
  “confidence”: “confidence about the percentage accuracy between
mixtral and gpt response”
  },
  <Main issue>: {
  “answer”: “your answer concisely in word(s)”,
  },
  <Technique>: {
  “answer”: “your answer concisely in word(s)”,
  },
  <Solution>: [{
  “answer”: “Added required sentence. If your suggested sentences
already exist in the prompt, or if similar ones are present, please modify it
accordingly.”,
  “Should be added after this sentence”: “selected sentence between
<MODIFIED PROMPT START> and <MODIFIED PROMPT END> section
which answer sentence should be added after that. This selected sentence
SHOULD NOT be outside of <MODIFIED PROMPT START> and <MODIFIED
PROMPT END> tags, so double check selected sentences.”
  }],
  <three shot example>: [{
  “answer”: “General Few shot example to help model”
  }]
  }
```

The larger model 740 output may then optionally be processed 745 to extract portions thereof (e.g., queries, modified prompts, accuracy estimates) and then assessed 747 to determine whether the model-specific prompt generation process 700 can complete (e.g., by comparing one or more accuracy estimates in the larger model 740 output to a threshold accuracy value). If the accuracy is greater than the threshold value, a modified model-specific prompt may be extracted from the larger model 740 output and then applied to the smaller model 730 to perform the task in an improved manner while still obtaining the reduced power and computational costs and other benefits associated with use of the smaller model 730. If the accuracy is less than the threshold value, then modified queries, modified task prompts, or other contents of the larger model 740 output may be used to generate an updated prompt. The updated prompt can then be presented to the smaller model 730 to generate output that can then be re-assessed by the larger model 740, with the process being iterated until the accuracy indicated by the larger model 740 output exceeds the threshold value (or a maximum number of iterations is performed or some other end condition is met).

### VIII. Example Operations

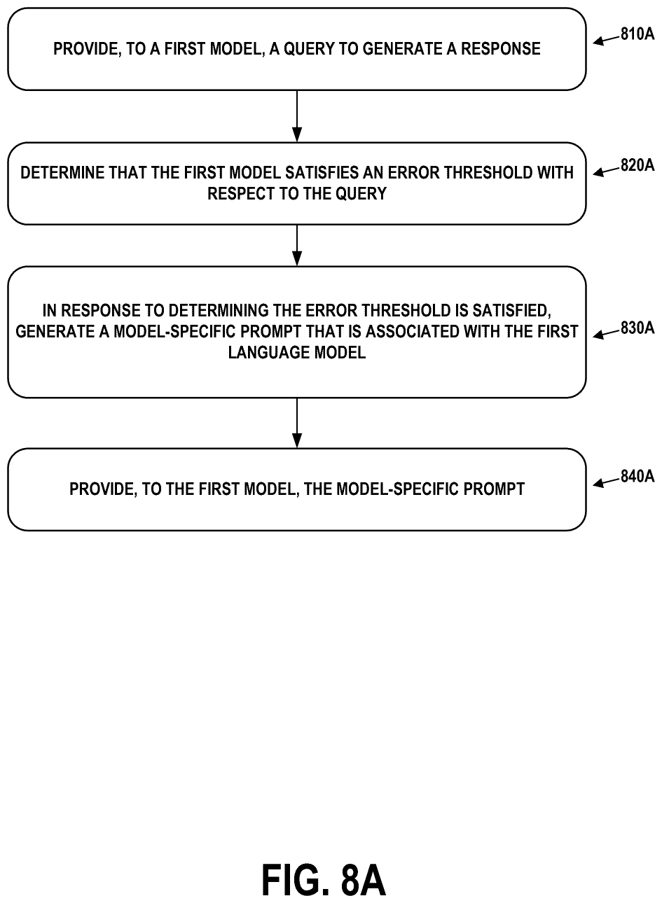

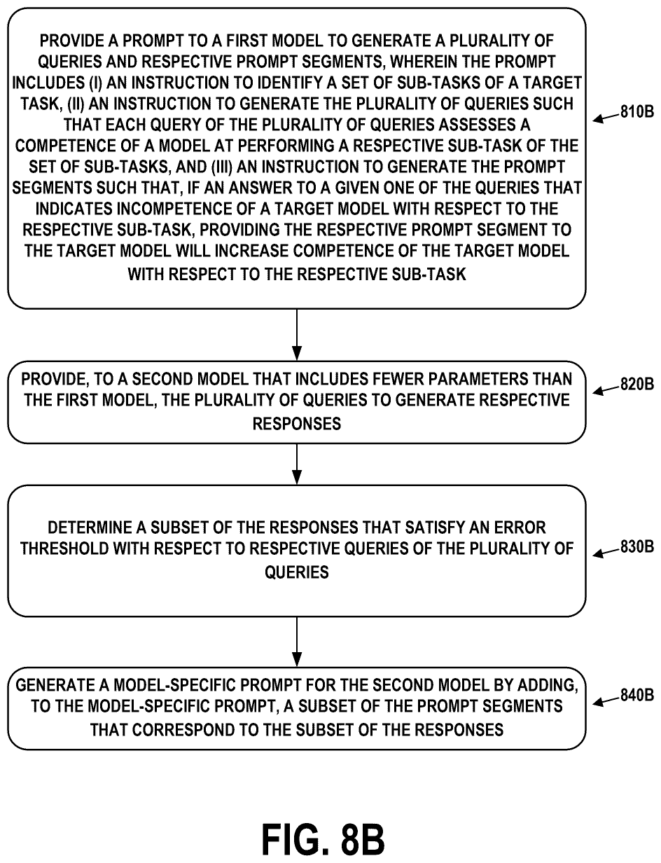

FIGS. 8A and 8B are flow charts illustrating an example embodiments. The processes illustrated by FIGS. 8A and 8B may be carried out by a computing device, such as computing device 100, and/or a cluster of computing devices, such as server cluster 200. However, the process can be carried out by other types of devices or device subsystems. For example, the process could be carried out by a computational instance of a remote network management platform or a portable computer, such as a laptop or a tablet device.

The embodiments of FIGS. 8A and 8B may be simplified by the removal of any one or more of the features shown therein. Further, these embodiments may be combined with features, aspects, and/or implementations of any of the previous figures or otherwise described herein.

The embodiments of FIG. 8A include providing, to a first model, a query to generate a response (810A). The embodiments of FIG. 8A additionally include determining that the first model satisfies an error threshold with respect to the query (820A). This can include (i) providing, to a second model that includes more parameters than the first model, the first model's response to the query; and (ii) receiving, from the second model, an error score that satisfies the error threshold. Determining that the first model satisfies the error threshold can additionally include providing, to the second model, a model answer that is associated with the query.

In some examples, providing the query to generate the response can include providing multiple sub-queries to the first model to generate respective sub-responses, and generating a model-specific prompt that is associated with the first language model can include: (i) providing the sub-queries and the sub-responses to a second model that includes more parameters than the first model to generate the model-specific prompt and an updated query; (ii) providing, to the first model, the updated query to generate a second response; (iii) determining that the first model satisfies an error threshold with respect to the updated query; and (iv) in response to determining the error threshold is satisfied with respect to the updated query, updating the model-specific prompt. In such examples, determining that the first model satisfies the error threshold with respect to the query can include determining that the sub-responses are less accurate than a threshold accuracy with respect to the sub-queries, for example, determining that the sub-responses are less accurate than the threshold accuracy can include providing, to the second model, a prompt that includes the sub-queries, the sub-responses, and an instruction to estimate the accuracy of the sub-responses with respect to the sub-queries.

The embodiments of FIG. 8A additionally include, in response to determining the error threshold is satisfied, generating a model-specific prompt that is associated with the first language model (830A). In some examples, determining that the first language model satisfies the error threshold can include identifying a sub-portion of the query that the first model is not competent to process, and generating the model-specific prompt can include adding, to the model-specific prompt, a prompt segment based on the sub-portion. Generating the model-specific prompt can include adding, to the model-specific prompt, a prompt segment that is associated with the query.

Generating the model-specific prompt (830A) can include traversing a graph. In such examples, the query and the prompt segment are associated with a first node of a graph, a second node of the graph is associated with a second query and a second prompt segment, and traversing the graph includes, in response to determining the error threshold is satisfied: (i) providing, to the first model, the second query to generate a second response; (ii) determining that the first model satisfies an error threshold with respect to the second query; and (iii) in response to determining the error threshold is satisfied with respect to the second query, adding, to the model-specific prompt, the second prompt segment. In such examples, a third node of the graph can be associated with a third query and a third prompt segment, traversing the graph can additionally include (i) providing, to the first model, the third query to generate a third response and (ii) determining that the first model does not satisfy an error threshold with respect to the third query, and the embodiments of FIG. 8A the further include: (a) traversing the graph a second time to generate a second model-specific prompt for a second model, wherein traversing the graph the second time comprises (1) providing, to the second model, the third query to generate a fourth response; (2) determining that the second model satisfies an error threshold with respect to the third query; and (3) in response to determining the second model satisfied the error threshold with respect to the third query, adding, to the second model-specific prompt, the third prompt segment; and (b) providing, to the second model, the second model-specific prompt.

The embodiments of FIG. 8A additionally include providing, to the first model, the model-specific prompt (840A). This provides the benefit of obtaining high-accuracy performance of a task using the relatively lower power and computational cost of the smaller first model. This benefit is obtained since the model-specific prompt, having been generated as described herein, represents context, instructions, and other information determined by a larger model (which is more expensive with respect to power and computational resources to execute) to improve the performance of the smaller first model with respect to the task. These benefits are also obtained without accruing the significant training data, power, and other computational costs that would be involved in fine-tuning or otherwise training such a smaller first model to perform the task with higher accuracy.

The embodiments of FIG. 8A may additionally include: (i) providing, to a second model, the query to generate a second response; (ii) determining that the second model satisfies the error threshold with respect to the query; (iii) in response to determining the second model satisfies the error threshold with respect to the query, generating a second model-specific prompt that is associated with the second language model and that differs from the model-specific prompt provided to the first model; and (iv) providing, to the second model, the second model-specific prompt. In some examples, the second model is an updated version of the first model.

The embodiments of FIG. 8B include providing a prompt to a first model to generate a plurality of queries and respective prompt segments (810B). The prompt includes (i) an instruction to identify a set of sub-tasks of a target task, (ii) an instruction to generate the plurality of queries such that each query of the plurality of queries assesses a competence of a model at performing a respective sub-task of the set of sub-tasks, and (iii) an instruction to generate the prompt segments such that, if an answer to a given one of the queries that indicates incompetence of a target model with respect to the respective sub-task, providing the respective prompt segment to the target model will increase competence of the target model with respect to the respective sub-task. The prompt provided to the first model can include at least a portion of a knowledgebase entry describing the target task, an instruction to order the sub-tasks with respect to a familiarity of the first model with the sub-tasks, and/or an instruction to generate answers for each of the queries.

The embodiments of FIG. 8B also include providing, to a second model that includes fewer parameters than the first model, the plurality of queries to generate respective responses (820B). The embodiments of FIG. 8B also include determining a subset of the responses that satisfy an error threshold with respect to respective queries of the plurality of queries (830B).

The embodiments of FIG. 8B also include generating a model-specific prompt for the second model by adding, to the model-specific prompt, a subset of the prompt segments that correspond to the subset of the responses (840B). This provides the benefit of obtaining high-accuracy performance of a task using the relatively lower power and computational cost of the smaller second model. This benefit is obtained since the model-specific prompt, having been generated as described herein, represents context, instructions, and other information determined by the larger first model (which is more expensive with respect to power and computational resources to execute) to improve the performance of the smaller second model with respect to the task. These benefits are also obtained without accruing the significant training data, power, and other computational costs that would be involved in fine-tuning or otherwise training such a smaller second model to perform the task with higher accuracy.

The embodiments of FIG. 8B can also include generating a graph whose nodes correspond to respective sets of the queries and prompt segments, providing the plurality of queries to the second model, determining the subset of the responses, and generating the model-specific prompt for the second model can include traversing the graph.

### IX. Closing

The present disclosure is not to be limited in terms of the particular embodiments described in this application, which are intended as illustrations of various aspects. Many modifications and variations can be made without departing from its scope, as will be apparent to those skilled in the art. Functionally equivalent methods and apparatuses within the scope of the disclosure, in addition to those described herein, will be apparent to those skilled in the art from the foregoing descriptions. Such modifications and variations are intended to fall within the scope of the appended claims.

The above detailed description describes various features and operations of the disclosed systems, devices, and methods with reference to the accompanying figures. The example embodiments described herein and in the figures are not meant to be limiting. Other embodiments can be utilized, and other changes can be made, without departing from the scope of the subject matter presented herein. It will be readily understood that the aspects of the present disclosure, as generally described herein, and illustrated in the figures, can be arranged, substituted, combined, separated, and designed in a wide variety of different configurations.

With respect to any or all of the message flow diagrams, scenarios, and flow charts in the figures and as discussed herein, each step, block, and/or communication can represent a processing of information and/or a transmission of information in accordance with example embodiments. Alternative embodiments are included within the scope of these example embodiments. In these alternative embodiments, for example, operations described as steps, blocks, transmissions, communications, requests, responses, and/or messages can be executed out of order from that shown or discussed, including substantially concurrently or in reverse order, depending on the functionality involved. Further, more or fewer blocks and/or operations can be used with any of the message flow diagrams, scenarios, and flow charts discussed herein, and these message flow diagrams, scenarios, and flow charts can be combined with one another, in part or in whole.

A step or block that represents a processing of information can correspond to circuitry that can be configured to perform the specific logical functions of a herein-described method or technique. Alternatively or additionally, a step or block that represents a processing of information can correspond to a module, a segment, or a portion of program code (including related data). The program code can include one or more instructions executable by a processor for implementing specific logical operations or actions in the method or technique. The program code and/or related data can be stored on any type of non-transitory computer readable medium such as a storage device including RAM, ROM, a disk drive, a solid-state drive, or another tangible storage medium.

Moreover, a step or block that represents one or more information transmissions can correspond to information transmissions between software and/or hardware modules in the same physical device. However, other information transmissions can be between software modules and/or hardware modules in different physical devices.

The particular arrangements shown in the figures should not be viewed as limiting. It should be understood that other embodiments could include more or less of each element shown in a given figure. Further, some of the illustrated elements can be combined or omitted. Yet further, an example embodiment can include elements that are not illustrated in the figures.

While various aspects and embodiments have been disclosed herein, other aspects and embodiments will be apparent to those skilled in the art. The various aspects and embodiments disclosed herein are for purpose of illustration and are not intended to be limiting, with the true scope being indicated by the following claims.

What is claimed is:

1. A method comprising:
providing, to a first model, a query to generate a response;
determining that the first model satisfies an error threshold with respect to the query;
in response to determining the error threshold is satisfied, generating a model-specific prompt that is associated with the first model; and
providing, to the first model, the model-specific prompt.

2. The method of claim 1, wherein determining that the first model satisfies the error threshold comprises identifying a sub-portion of the query that the first model is not competent to process, and wherein generating the model-specific prompt comprises adding, to the model-specific prompt, a prompt segment based on the sub-portion.

3. The method of claim 1, wherein determining that the first model satisfies the error threshold comprises:
providing, to a second model that includes more parameters than the first model, a response to the query from the first model; and
receiving, from the second model, an error score that satisfies the error threshold.

4. The method of claim 3, wherein determining that the first model satisfies the error threshold additionally comprises providing, to a second model, a model answer that is associated with the query.

5. The method of claim 1, wherein generating the model-specific prompt comprises adding, to the model-specific prompt, a prompt segment that is associated with the query.

6. The method of claim 5, wherein generating the model-specific prompt comprises traversing a graph, wherein the query and the prompt segment are associated with a first node of a graph, wherein a second node of the graph is associated with a second query and a second prompt segment, and wherein traversing the graph comprises, in response to determining the error threshold is satisfied:
providing, to the first model, the second query to generate a second response;
determining that the first model satisfies an error threshold with respect to the second query; and
in response to determining the error threshold is satisfied with respect to the second query, adding, to the model-specific prompt, the second prompt segment.

7. The method of claim 6, wherein a third node of the graph is associated with a third query and a third prompt segment, wherein traversing the graph additionally comprises (i) providing, to the first model, the third query to generate a third response and (ii) determining that the first model does not satisfy an error threshold with respect to the third query, and wherein the method further comprises:
traversing the graph a second time to generate a second model-specific prompt for a second model, wherein traversing the graph the second time comprises (i) providing, to the second model, the third query to generate a fourth response; (ii) determining that the second model satisfies an error threshold with respect to the third query; and (iii) in response to determining the second model satisfied the error threshold with respect to the third query, adding, to the second model-specific prompt, the third prompt segment
providing, to the second model, the second model-specific prompt.

8. The method of claim 1, wherein providing the query to generate the response comprises providing multiple sub-queries to the first model to generate respective sub-responses, and wherein generating a model-specific prompt that is associated with the first model comprises:
providing the sub-queries and the sub-responses to a second model that includes more parameters than the first model to generate the model-specific prompt and an updated query;
providing, to the first model, the updated query to generate a second response;
determining that the first model satisfies an error threshold with respect to the updated query; and
in response to determining the error threshold is satisfied with respect to the updated query, updating the model-specific prompt.

9. The method of claim 8, wherein determining that the first model satisfies the error threshold with respect to the query comprises determining that the sub-responses are less accurate than a threshold accuracy with respect to the sub-queries.

10. The method of claim 9, wherein determining that the sub-responses are less accurate than the threshold accuracy comprises providing, to the second model, a prompt that includes the sub-queries, the sub-responses, and an instruction to estimate an accuracy of the sub-responses with respect to the sub-queries.

11. The method of claim 1, further comprising:
providing, to a second model, the query to generate a second response;
determining that the second model satisfies the error threshold with respect to the query;
in response to determining the second model satisfies the error threshold with respect to the query, generating a second model-specific prompt that is associated with the second model and that differs from the model-specific prompt provided to the first model; and
providing, to the second model, the second model-specific prompt.

12. The method of claim 11, wherein the second model is an updated version of the first model.

13. A method comprising:
providing a prompt to a first model to generate a plurality of queries and respective prompt segments, wherein the prompt includes (i) an instruction to identify a set of sub-tasks of a target task, (ii) an instruction to generate the plurality of queries such that each query of the plurality of queries assesses a competence of a model at performing a respective sub-task of the set of sub-tasks, and (iii) an instruction to generate the prompt segments such that, if an answer to a given one of the queries that indicates incompetence of a target model with respect to the respective sub-task, providing the respective prompt segment to the target model will increase competence of the target model with respect to the respective sub-task;
providing, to a second model that includes fewer parameters than the first model, the plurality of queries to generate respective responses;
determining a subset of the responses that satisfy an error threshold with respect to respective queries of the plurality of queries; and
generating a model-specific prompt for the second model by adding, to the model-specific prompt, a subset of the prompt segments that correspond to the subset of the responses.

14. The method of claim 13, wherein the prompt provided to the first model includes at least a portion of a knowledgebase entry describing the target task.

15. The method of claim 13, wherein the prompt provided to the first model includes an instruction to order the sub-tasks with respect to a familiarity of the first model with the sub-tasks.

16. The method of claim 13, wherein the prompt provided to the first model includes an instruction to generate answers for each of the queries.

17. The method of claim 13, further comprising:
generating a graph whose nodes correspond to respective sets of the queries and prompt segments, wherein providing the plurality of queries to the second model, determining the subset of the responses, and generating the model-specific prompt for the second model comprises traversing the graph.

18. A non-transitory computer-readable medium, having stored thereon program instructions that, upon execution by a computing system, cause the computing system to perform operations comprising:
providing, to a first model, a query to generate a response;
determining that the first model satisfies an error threshold with respect to the query;
in response to determining the error threshold is satisfied, generating a model-specific prompt that is associated with the first model; and
providing, to the first model, the model-specific prompt.

19. The non-transitory computer-readable medium of claim 18, wherein determining that the first model satisfies the error threshold comprises identifying a sub-portion of the query that the first model is not competent to process, and wherein generating the model-specific prompt comprises adding, to the model-specific prompt, a prompt segment based on the sub-portion.

20. The non-transitory computer-readable medium of claim 18, wherein generating the model-specific prompt comprises adding, to the model-specific prompt, a prompt segment that is associated with the query.
